(19) United States
(12) Patent Application Publication
(10) Pub. No.: US 2026/0230925 A1
(43) Pub. Date: Aug. 6, 2026

(54) METHOD AND DEVICE FOR DISCARDING WIRELESS LINK CONTROL SERVICE DATA UNIT IN WIRELESS COMMUNICATION SYSTEM

(71) Applicant: Samsung Electronics Co., Ltd., Gyeonggi-do (KR)

(72) Inventors: Jeongseok YU, Gyeonggi-do (KR); Anil AGIWAL, Gyeonggi-do (KR); Sangkyu BAEK, Gyeonggi-do (KR)

(21) Appl. No.: 19/154,496

(22) PCT Filed: Jan. 25, 2024
(86) PCT No.: PCT/KR2024/001170

§ 371 Date: Aug. 7, 2025

(30) Foreign Application Priority Data
Feb. 10, 2023 (KR) 10-2023-0018302

(51) Int. Cl. H04W 28/04; H04L 1/1607; H04W 28/06

(52) U.S. Cl. CPC H04W 28/04; H04L 1/1642; H04W 28/06

(57) ABSTRACT

The present disclosure relates to a 5G or 6G communication system for supporting higher data transmission rates. An operating method of a RLC transmission part in a wireless communication system, according to one embodiment of the present disclosure, comprises the steps of: receiving discard request messages for one or more RLC SDUs from an upper layer, discarding the one or more RLC SDUs transferred, in RLC PDU form, to a lower layer if the discard request messages are received; and transmitting, to a reception part of a counterpart RLC, information about one or more RLC SNs corresponding to one or more discarded RLC SDUs.

### TECHNICAL FIELD

The disclosure generally relates to a wireless communication system and, more particularly, to a method and device for discarding a radio link control service data unit in a wireless communication system.

### Background Art

5G mobile communication technologies define broad frequency bands to enable high transmission rates and new services, and can be implemented not only in “Sub 6 GHz” bands such as 3.5 GHz, but also in ultrahigh frequency (“Above 6 GHZ”) bands referred to as mmWave such as 28 GHz and 39 GHz. In addition, it has been considered to implement 6G mobile communication technologies (referred to as Beyond 5G systems) in terahertz bands (e.g., 95 GHz to 3 THz bands) in order to accomplish transmission rates fifty times faster than 5G mobile communication technologies and ultra-low latencies one-tenth of 5G mobile communication technologies.

At the beginning of 5G mobile communication technologies, in order to support services and to satisfy performance requirements in connection with enhanced Mobile BroadBand (eMBB), Ultra Reliable & Low Latency Communications (URLLC), and massive Machine-Type Communications (mMTC), there has been ongoing standardization regarding beamforming and massive MIMO for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large-capacity data transmission and a polar code for highly reliable transmission of control information, L2 pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as Vehicle-to-everything (V2X) for aiding driving determination by autonomous vehicles based on information regarding positions and states of vehicles transmitted by the vehicles and for enhancing user convenience, New Radio Unlicensed (NR-U) aimed at system operations conforming to various regulation-related requirements in unlicensed bands, NR UE Power Saving, Non-Terrestrial Network (NTN) which is UE-satellite direct communication for securing coverage in an area in which communication with terrestrial networks is unavailable, and positioning.

Moreover, there has been ongoing standardization in wireless interface architecture/protocol fields regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service fields regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting Augmented Reality (AR), Virtual Reality (VR), Mixed Reality (MR), etc., 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for securing coverage in terahertz bands of 6G mobile communication technologies, Full Dimensional MIMO (FD-MIMO), multi-antenna transmission technologies such as array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure provides a method and device for discarding a radio link control service data unit in a wireless communication system so as to effectively provide a service.

The technical subjects pursued in the disclosure may not be limited to the above-mentioned technical subjects, and other technical subjects which are not mentioned herein may be clearly understood from the following description by those skilled in the art to which the disclosure pertains.

### Solution to Problem

An operation method of a radio link control (RLC) transmitting side in a wireless communication system according to an embodiment of the disclosure may include an operation of receiving, from an upper layer, a message for requesting discarding of at least one radio link control (RLC) service data unit (SDU), an operation of discarding the at least one RLC SDU transferred to a lower layer (lower layers) in the form of a protocol data unit when the discard request message is received, and an operation of transmitting, to a receiving side of a peer RLC, information associated with at least one RLC sequence number (SN) corresponding to the at least one discarded RLC SDU.

### Advantageous Effects of Invention

According to an embodiment of the disclosure, a device and a method capable of effectively providing services in a wireless communication system can be provided.

Advantageous effects obtainable from the disclosure may not be limited to the above-mentioned effects, and other effects which are not mentioned herein may be clearly understood from the following description by those skilled in the art to which the disclosure pertains.

### BRIEF DESCRIPTION OF DRAWINGS

FIG. 1 illustrates a structure of a next-generation mobile communication system according to various embodiments of the disclosure.

FIG. 2 illustrates a user plane radio protocol structure of a next-generation mobile communication system according to various embodiments of the disclosure.

FIG. 3 illustrates a control plane radio protocol structure of a next-generation mobile communication system according to various embodiments of the disclosure.

FIG. 4 is a diagram illustrating a structure of a protocol data unit set (PDU set) according to various embodiments of the disclosure.

FIG. 5 is a flowchart illustrating operation of a PDCP transmission entity and a service data unit discarding operation according to various embodiments of the disclosure.

FIG. 6 is a flowchart illustrating a process in which a base station configures RLC service data unit discarding for a UE according to various embodiments of the disclosure,

FIG. 7 is a flowchart illustrating operation of an RLC transmitting side and a service data unit discarding operation according to various embodiments of the disclosure.

FIG. 8 is a diagram illustrating a method of informing a peer RLC of a discarded RLC SN in the form of a UMD PDU according to various embodiments of the disclosure.

FIG. 9 is a diagram illustrating a method of informing a peer RLC of a discarded RLC SN in the form of an AMD PDU according to various embodiments of the disclosure.

FIG. 10 is a diagram illustrating a method of informing a peer RLC of a discarded RLC SN in the form of a CONTRL PDU according to various embodiments of the disclosure.

FIG. 11 is a flowchart illustrating operation of an RLC receiving side according to various embodiments of the disclosure.

FIG. 12 is a block diagram illustrating an internal structure of a base station according to various embodiments of the disclosure.

FIG. 13 is a block diagram illustrating a structure of a UE according to various embodiments of the disclosure.

### MODE FOR THE INVENTION

Hereinafter, embodiments of the disclosure will be described in detail with reference to the accompanying drawings.

In describing the embodiments, descriptions related to technical contents well-known in the relevant art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Also, the size of each element does not completely reflect the actual size. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements. Furthermore, in describing the disclosure, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

The following detailed description of embodiments of the disclosure is mainly directed to New RAN (NR) as a radio access network and Packet Core (5G system or 5G core network or next generation core (NG Core)) as a core network in the 5G mobile communication standards specified by the 3rd generation partnership project (3GPP) that is a mobile communication standardization group, but based on determinations by those skilled in the art, the main idea of the disclosure may be applied to other communication systems having similar backgrounds through some modifications without significantly departing from the scope of the disclosure.

In the following description, some of terms and names defined in the 3GPP standards (standards for 5G, NR, LTE, or similar systems) may be used for the sake of descriptive convenience. However, the disclosure is not limited by these terms and names, and may be applied in the same way to systems that conform other standards.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as used herein, and other terms referring to subjects having equivalent technical meanings may be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

A wireless communication system is advancing to a broadband wireless communication system for providing high-speed and high-quality packet data services using communication standards, such as high-speed packet access (HSPA) of 3GPP, LTE (long-term evolution or evolved universal terrestrial radio access (E-UTRA)), LTE-Advanced (LTE-A), LTE-Pro, high-rate packet data (HRPD) of 3GPP2, ultra-mobile broadband (UMB), IEEE 802.16e, and the like, as well as typical voice-based services.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink refers to a radio link via which a user equipment (UE) or a mobile station (MS) transmits data or control signals to a base station (BS) (or eNode B), and the downlink refers to a radio link via which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. Also, the data rate required for the 5G communication system may be obtained using a frequency bandwidth more than 20 MHz in a frequency band of 3 to 6 GHz or 6 GHz or more, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km²) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

Lastly, URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

The three services in 5G, that is, eMBB, URLLC, and mMTC, may be multiplexed and transmitted in a single system. In this case, different transmission/reception techniques and transmission/reception parameters may be used between services in order to satisfy different requirements of the respective services. Of course, 5G is not limited to the three services described above.

The following disclosure relates to a method and device for discarding a radio link control (RLC) service data unit (SDU) in a wireless communication system. Specifically, when a request for discarding at least one RLC SDU is received from an upper layer, a transmitting side of an RLC may discard an RLC SDU transferred to lower layers in the form of an RLC protocol data unit (PDU), In addition, the transmitting side of the RLC may report, to a receiving side of a peer RLC, at least one RLC sequence number (SN) corresponding to a discarded RLC SDU. When the discarded RLC SDU is indicated, the receiving side of the RLC may process all byte segments as received, irrespective of reception of a segment of the discarded RLC SDU, and may not transmit the RLC SDU to an upper layer.

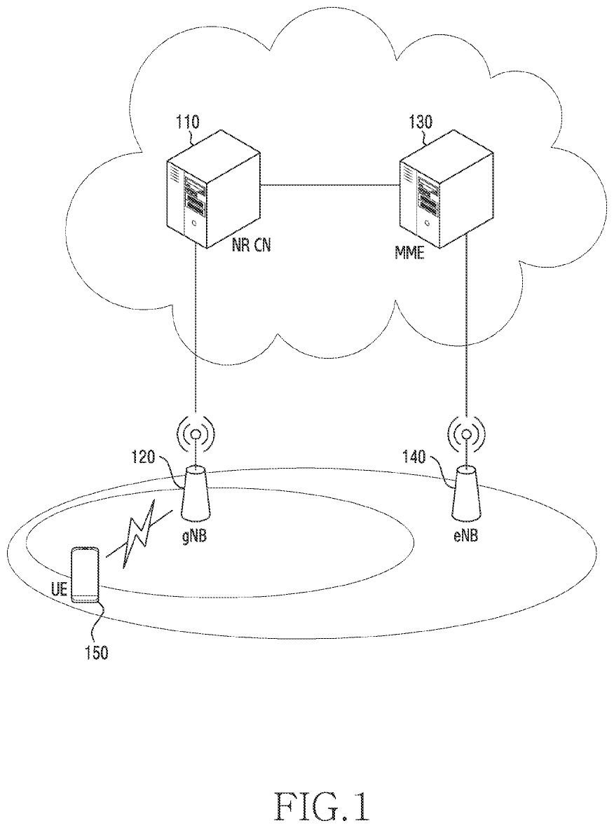

FIG. 1 illustrates a structure of a next-generation mobile communication system according to various embodiments of the disclosure.

Referring to FIG. 1, a radio access network of a next-generation mobile communication system (hereinafter NR or 5G) may include a next-generation base station (new radio node B, hereinafter NR gNB, gNB, or base station) 120, and a new radio core network (NR CN) 110. A user terminal (new radio user equipment, hereinafter NR UE or terminal) 150 may access an external network via the NR gNB 120 and the NR CN 110.

In FIG. 1, the NR gNB 120 may correspond to an eNB 140 of an LTE system. The NR gNB 120 may be connected to the NR UE 150 through a radio channel and provide outstanding services as compared to the eNB 140. In the next-generation mobile communication system, since all user traffic is serviced through a shared channel, a device that collects state information, such as buffer statuses, available transmit power states, and channel states of UEs, and performs scheduling accordingly is required, and the NR gNB 120 may serve as the device. In general, one NR gNB 120 may control multiple cells. In order to implement ultrahigh-speed data transfer beyond LTE, a wider bandwidth than the maximum bandwidth of LTE may be used, an orthogonal frequency division multiplexing (OFDM) scheme may be employed as a radio access technology, and a beamforming technology may be additionally integrated therewith. Furthermore, an adaptive modulation and coding (AMC) scheme for determining a modulation scheme and a channel coding rate according to a channel state of a UE may be employed. The NR CN 110 may perform functions such as mobility support, bearer configuration, and QoS configuration. The NR CN 110 is a device responsible for various control functions as well as a mobility management function for a UE, and may be connected to multiple base stations. In addition, the next-generation mobile communication system may interwork with the existing LTE system, and the NR CN 110 may be connected to an MME 130 via a network interface. The MME 130 may be connected to the eNB 140.

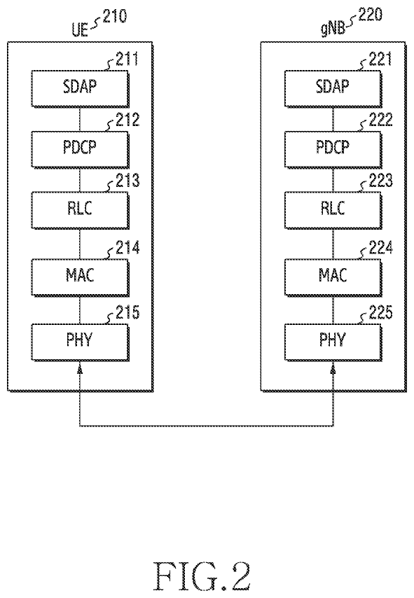

FIG. 2 illustrates a user plane radio protocol structure of a next-generation mobile communication system according to various embodiments of the disclosure.

Referring to FIG. 2, on a UE 210 side, a user plane radio protocol of a next-generation mobile communication system may include a service data association protocol (SDAP) 211, a packet data convergence protocol (PDCP) 212, an RLC 213, a medium access control (MAC) 214, and/or a physical (PHY) 215. On a gNB 220 side, a user plane radio protocol of a next-generation mobile communication system may include an SDAP 221, a PDCP 222, an RLC 223, an MAC 224, and/or a PHY 225. In the disclosure, the expression “may include” may be replaced with the expression “may consist of”. For example, on a UE 210 side, a user plane radio protocol of a next-generation mobile communication system may consist of an SDAP 211, a PDCP 212, an RLC 213, an MAC 214, and/or a PHY 215.

The main functions of the SDAP 211 or 221 may include some of functions below.
Mapping between a quality of service (QoS) flow and a data radio bearer
Marking QoS flow ID (QFI) in both DL and UL packets

The main functions of the PDCP 212 or 222 may include some of functions below.
Transfer of data (user plane or control plane)
Maintenance of PDCP sequence numbers (SNs)
Header compression and decompression using ROHC protocol
Header compression and decompression using EHC protocol
Compression and decompression of uplink PDCP SDUs: DEFLATE based UDC only
Ciphering and deciphering
Integrity protection and integrity verification)
Timer based SDU discard
For split bearers, routing
Duplication
Reordering and in-order delivery
Out-of-order delivery
Duplicate discarding

The main functions of the RLC 213 or 223 may include some of functions below.
Transfer of upper layer PDUs
Sequence numbering independent of the one in PDCP (UM and AM)
Error correction through automatic repeat request (ARQ) (AM only)
Segmentation (AM and UM) and re-segmentation (AM only) of RLC SDUs
Reassembly of SDU (AM and UM)
Duplicate detection (AM only)
RLC SDU discard (AM and UM)
RLC re-establishment
Protocol error detection (AM only)

The main functions of the MAC 214 or 224 may include some of functions below.
Mapping between logical channels and transport channels
Multiplexing of MAC SDUs from one or different logical channels onto transport blocks (TBs) to be delivered to physical layer on transport channels
Demultiplexing of MAC SDUs to one or different logical channels from transport blocks (TBs) delivered from physical layer on transport channels
Scheduling information reporting
Error correction through hybrid automatic repeat request (HARQ)
Logical channel prioritization
Priority handling between overlapping resources of one UE

The PHY layer 215 or 225 may perform channel coding and modulation of upper layer data to generate OFDM symbols and may convert the OFDM symbols into an RF signal and then transmit the same through an antenna. In addition, the PHY layer 215 or 225 may perform demodulation and channel decoding of the received OFDM symbols and then transfer the OFDM symbols to an upper layer.

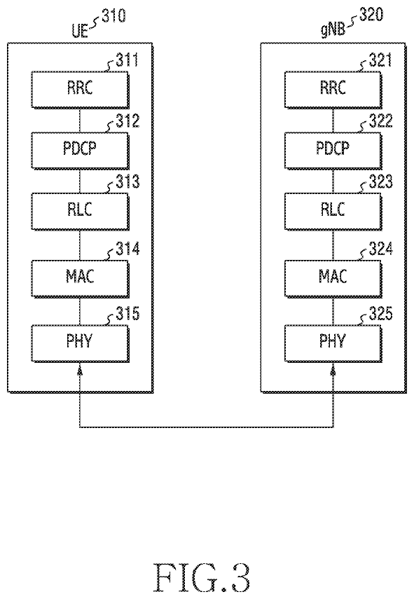

FIG. 3 is a diagram illustrating a control plane radio protocol architecture of a next generation mobile communication system according to various embodiments of the disclosure.

Referring to FIG. 3, for a UE 310, a control plane radio protocol of the next generation mobile communication system may include a radio resource control (RRC) 311, a PDCP 312, an RLC 313, a MAC 314, and/or a PHY 315. For a base station 320, it may include an RRC 321, a PDCP 322, an RLC 323, a MAC 324, and/or a PHY 325.

The functions of the RRC 311 or 312 may include at least some of the following functions.
Broadcasting system information (broadcast of system information related to AS and NAS)
Paging (paging initiated by 5GC or NG-RAN)
Establishing and managing an RRC connection between a UE and an NG-RAN, carrier aggregation, and adding, modifying, and releasing dual connectivity between NRs or between NR and LTE (establishment, maintenance and release of an RRC connection between the UE and NG-RAN including: addition, modification and release of carrier aggregation; addition, modification and release of dual connectivity in NR or between E-UTRA and NR.)
Security function including key management (security functions including key management)
Establishing, configuring, maintaining, and releasing signaling radio bearers and data radio bearers (establishment, configuration, maintenance and release of signaling radio bearers (SRBs) and data radio bearers (DRBs))
Supporting UE mobility (mobility functions including: handover and context transfer; UE cell selection and reselection and control of cell selection and reselection; inter-RAT mobility.)
QoS management functions
UE measurement reporting and control of the reporting
Detection of and recovery from radio link failure
Non-access stratum (NAS) message transmission (NAS message transfer to/from NAS from/to UE)

The main functions of PDCP 312 or 322, RLC 313 or 323, MAC 314 or 324, and/or PHY 315 or 325 may be based on the example of FIG. 2.

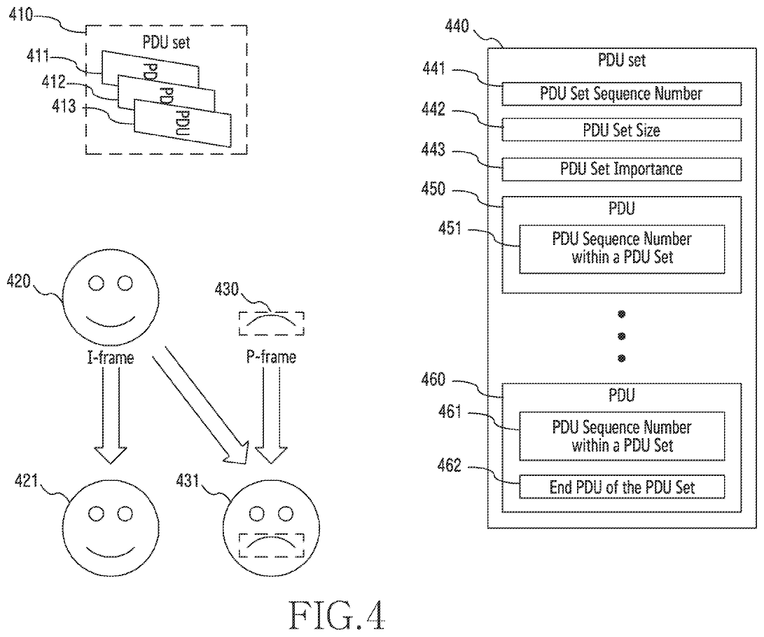

FIG. 4 is a diagram illustrating a structure of a protocol data unit set (PDU set) according to various embodiments of the disclosure.

Referring to FIG. 4, various types of traffics may be distinguished based on an information unit (application data unit (ADU)) that may be distinguished at the application level. For example, it may be a single image or picture, a single frame of a video, or a single audio unit. Such data may be identified in units of PDU sets 410, and the PDU set 410 may be divided into at least one or more PDUs 411, 412, and 413 based on a size for transmission.

For example, in the case of using moving picture experts group (MPEG) standard video compression technology for video traffic, the PDU set 410 may be a PDU set that configures a single intra (I)-frame with at least one PDU, a PDU set that configures a single predicted (P)-frame with at least one PDU, or a PDU set that configures a single bidirectional (B)-frame with at least one PDU. An I-frame 420 is an independent frame and may represent a single intact image or picture 421 irrespective of existence of another frame. A P-frame 430 is a frame representing changed information as compared to the previous I-frame 420, and, when the I-frame 420 is not properly received, an image or picture 431 to be represented via the I-frame 420 and the P-frame 430 may not be represented normally. A B-frame is a frame representing midpoint information of a change between two different I-frames or a change between an I-frame and a P-frame, and may store a movement between two different frames as predicted data and thus, when both the two frames are received properly, an image or picture to be represented by the B-frame and the two different frames may be normally represented.

The PDU set 440 may include a PDU set SN 441 and/or a PDU set size 442, and/or PDU set importance 443 in order to distinguish from different PDU sets in a single QoS flow and to perform PDU set handling. The PDU set importance 443 may be used to determine relative or absolute importance of one PDU set 440 in one QoS flow. A base station or a user equipment (UE) may discard at least one PDU included in at least one PDU set by using the PDU set SN 441, and/or PDU set size 442, and/or PDU set importance 443. At least one PDU 450 or 460 included in the PDU set 440 may include a PDU SN 451 or 461 indicating what numbered PDU in the PDU set 440 and/or end PDU information 462 indicating the last PDU in the PDU set 440.

The information 441, 442, or 443 included in the PDU set 440 and information 451, 461, or 462 included in the PDU 450 or 460 in the PDU set may be included in a GTP-U header and may be transferred from a UPF to the base station in the case of a downlink, and, in the case of an uplink, may be transferred to an SDAP and/or PDCP via a process of transmitting the PDU set 440 or the PDU 450 or 460 included therein via a QoS flow in the UE's application layer and/or the base station's configuration.

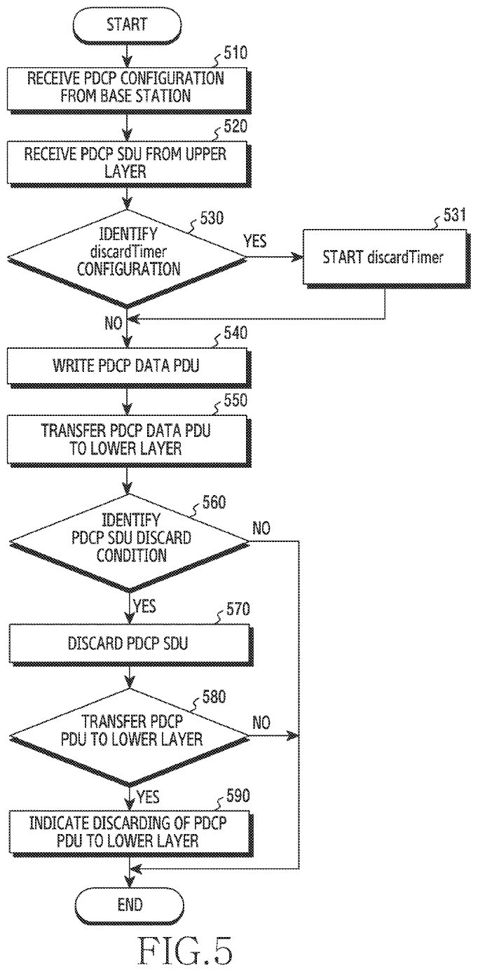

FIG. 5 is a flowchart illustrating operation of a PDCP transmission entity and a service data unit discarding operation according to various embodiments of the disclosure.

Referring to FIG. 5, in operation 510, a base station may transfer (or transmit) a PDCP entity's configuration information corresponding to a data radio bearer (DRB) via RRC signaling, and the configuration that may be transferred may be as shown in the example in Table 1.

TABLE 1

| PDCP-Config ::= | | SEQUENCE { |
|---|---|---|
| | drb | SEQUENCE { |

| | |
|---|---|
| discardTimer | ENUMERATED { [symbol] , [symbol] , [symbol] , [symbol] , [symbol] , [symbol] , [symbol] , |

[symbol]

100, [symbol] 1 [symbol] 0, [symbol] 200,

| | | [symbol] , [symbol] 300, [symbol] 500, [symbol] 750, [symbol] , infinity} |
|---|---|---|
| OPTIONAL, | -- Cond Setup | |
| | pd [symbol] p- [symbol] | ENUMERATED { [symbol] bits, [symbol] bits} |
| OPTIONAL, | -- Cond Setup1 | |
| | gd [symbol] p- [symbol] | ENUMERATED { [symbol] bits, [symbol] bits} |

| OPTIONAL, | -- Cond Setup2 | |
|---|---|---|
| | headerCompression | CHOICE { |
| | notUsed | NULL, |
| | [symbol] oho | SEQUENCE { |

| | |
|---|---|
| maxCID | INTEGER {1..16383} |

DEFAULT [symbol] ,

| | |
|---|---|
| profiles | SEQUENCE { |
| profile [symbol] | BOOLEAN, |
| profile [symbol] | BOOLEAN, |
| profile [symbol] | BOOLEAN, |
| profile [symbol] | BOOLEAN, |
| profile [symbol] | BOOLEAN, |
| profile [symbol] | BOOLEAN, |
| profile [symbol] | BOOLEAN, |
| profile [symbol] | BOOLEAN, |
| profile [symbol] | BOOLEAN |

| }, | |
|---|---|
| dcb-Continue [symbol] | ENUMERATED { true } |

| OPTIONAL | -- Need N | |
|---|---|---|
| | }, | |
| | uplinkOnlyP [symbol] | SEQUENCE { |

| | |
|---|---|
| maxCIB | INTEGER {1..16383} |

DEFAULT [symbol] ,

| | |
|---|---|
| profiles | SEQUENCE { |
| profile0x0006 | BOOLEAN |

| }, | |
|---|---|
| drb-Continue [symbol] | ENUMERATED { true } |

| OPTIONAL | -- Need N | |
|---|---|---|
| | }, | |
| | ... | |
| | }, | |
| | integrityProtection | ENUMERATED { enabled } |
| OPTIONAL, | -- Cond Connected [symbol] | |
| | statusReportRequired | ENUMERATED { true } |
| OPTIONAL, | -- Cond [symbol] | |
| | out [symbol] Delivery | ENUMERATED { true } |

| OPTIONAL, | -- Need [symbol] | |
|---|---|---|
| | } | |
| OPTIONAL, | -- Cond [symbol] | |
| | more [symbol] | SEQUENCE { |
| | primary [symbol] | SEQUENCE { |

| | cellGroup | CellGroupId |
|---|---|---|
| OPTIONAL, | -- Need [symbol] | |
| | logicalChannel | LogicalChannelIdentity |
| OPTIONAL | -- Need [symbol] | |
| | }, | |
| | ul-Data [symbol] Threshold | UL-DataUplinkThreshold |
| OPTIONAL, | -- Cond SplitHea [symbol] | |
| | pdcp-Duplication | BOOLEAN |

| OPTIONAL | -- Need [symbol] | |
|---|---|---|
| | } | |
| OPTIONAL, | -- Cond MoreThanOne [symbol] | |
| | [symbol] -Reordering | ENUMERATED { |

ms0, ms1, ms2, ms4, ms5, ms8, ms10, ms15, ms20, ms30,

ms40,

ms50, ms60, ms80, ms100, ms120, ms140, ms160, ms180,

ms200, ms220,

```
      ms240, ms260, ms280, ms300, ms500, ms750, ms [symbol] 000, ms [symbol] 250,
      ms1500, ms1750, ms2000, ms2250, ms2500, ms2750,
      ms3000, spare28, spare27, spare26, spare25, spare24,
      spare23, spare22, spare21, spare20,
      spare19, spare18, spare17, spare16, spare15, spare14,
      spare13, spare12, spare11, spare10, spare09,
      spare08, spare07, spare06, spare05, spare04, spare03,
      spare02, spare01 }
```

OPTIONAL, -- Need S

| ..., | |
|---|---|
| [[ | |
| [symbol] ingDisabled | ENUMERATED {true} |

| | |
|---|---|
| OPTIONAL | -- Cond Connected [symbol] |
| | ]], |
| | [[ |

| | |
|---|---|
| discardTimerExt-r16 | Setup [symbol] { DiscardTimerExt-r16 } |

| | |
|---|---|
| OPTIONAL, | -- Cond DR [symbol] |

| | |
|---|---|
| moreThanTwo [symbol] - [symbol] R [symbol] -r16 | SEQUENCE { |

| | |
|---|---|
| splitSecondaryPath-r16 | LogicalChannelIdentity |

| | |
|---|---|
| OPTIONAL, | -- Cond [symbol] |

| | |
|---|---|
| duplicationS [symbol] -r16 | SEQUENCE (SIZE (3)) OF BOOLEAN |

| | |
|---|---|
| OPTIONAL | -- Need S |
| | } |
| OPTIONAL, | -- Cond MoreThan [symbol] |

| | |
|---|---|
| [symbol] HeaderCompression-r16 | SetupRelease { [symbol] netHeaderCompression-r16 } |

| | |
|---|---|
| OPTIONAL | -- Need N |
| | ]], |
| | [[ |

| | |
|---|---|
| survivalTimeStateSupport-r17 | ENUMERATED {true} |

| | |
|---|---|
| OPTIONAL, | -- Cond D [symbol] -Duplication |

| | |
|---|---|
| uplinkDataCompression-r17 | SetupRelease { UplinkDataCompression-r17 } |

| | |
|---|---|
| OPTIONAL, | -- Cond [symbol] |

| | |
|---|---|
| discardTimerExt2-r17 | SetupRelease { DiscardTimerExt2-r17 } |

| | |
|---|---|
| OPTIONAL, | -- Need M |

| | |
|---|---|
| initialRX-DELIV-r17 | BIT STRING (SIZE (32)) |

| | |
|---|---|
| OPTIONAL | -- Cond [symbol] -Initial [symbol] |
| | [symbol] |

```
      }
      EthernetHeaderCompression-r16 ::= SEQUENCE {
```

| [symbol] -Common-r16 | SEQUENCE { |
|---|---|
| [symbol] -Length-r16 | ENUMERATED { bits7, bits15 }, |
| ... | |
| }, | |
| [symbol] -Downlink-r1 [symbol] | SEQUENCE { |

| | |
|---|---|
| drb-Continue [symbol] - [symbol] -r16 | ENUMERATED { true } |

| | |
|---|---|
| OPTIONAL, | -- Need M |
| | ... |
| | } |
| OPTIONAL, | -- Need M |

| | |
|---|---|
| [symbol] -Uplink-r16 | SEQUENCE { |
| maxCID- [symbol] -UL-r16 | INTEGER (1.. [symbol] 2767), |

| | |
|---|---|
| drb-Continue [symbol] -UL-r16 | ENUMERATED { true } |

| | |
|---|---|
| OPTIONAL, | -- Need [symbol] |
| | ... |
| | } |
| OPTIONAL | -- Need [symbol] |

```
      }
      UL-DataSplitThreshold ::= ENUMERATED {
```

b0, b100, b200, b400, b800, b1600, b3200, b6400,

b12800, b25600, b51200, b102400, b204800,

b409600, b819200, b1228800, b1638400, b2457600,

b3276800, b40 [symbol] 6000, b [symbol] 915200, b5734400,

b6553600, infinity, spare8, spare7, spare6, spare5,

```
spare4, spare3, spare2, spare1}
      DiscardTimerExt-r16 ::= ENUMERATED { [symbol] , ms1, ms2, ms4, ms6, ms8, spare2, spare1}
      DiscardTimerExt2-r17 ::= ENUMERATED {ms [symbol] 000, spare3, spare2, spare1}
      UplinkDataCompression-r17 ::= CHOICE {
```

| | |
|---|---|
| [symbol] Setup | SEQUENCE { |
| bufferSize-r17 | ENUMERATED {kbyte2, kbyte4, kbyte8, spare1}, |

| | |
|---|---|
| dictionary-r17 | ENUMERATED { [symbol] -3DP, operator} |

| | |
|---|---|
| OPTIONAL | -- Need [symbol] |
| | }, |

| | |
|---|---|
| drb-Cont [symbol] | NULL |

} [symbol]
indicates data missing or illegible when filed

In operation 520, a transmission entity of a PDCP may receive a PDCP SDU from an upper layer.

In operation 530, the transmission entity of the PDCP may determine whether a discardTimer for a PDCP SDU or PDU set is configured in operation 510. When it is configured, the transmission entity of the PDCP may proceed with operation 531, and may start a discardTimer for the PDCP SDU received from the upper layer in operation 520 by using a discardTimer value configured in operation 510. When the discardTimer is not configured, a discardTimer may not be started.

In operation 540, the transmission entity of the PDCP may determine a count value for the PDCP SDU received from the upper layer in operation 520, may perform header compression using robust header compression (ROHC) or ethemet header compression (EHC), may perform uplink data compression, may perform integrity protection and ciphering by using TX_NEXT, and may determine an SN to be included in a PDCP Data PDU.

In operation 550, the transmission entity of the PDCP may transfer the PDCP Data PDU configured in operation 540 to a lower layer (e.g., one or more RLC entities). Operations 540 and 550 may be based on the example in Table 2.

TABLE 2

| | |
|---|---|
| 5.2.1 | Transmit operation |

At reception of a PDCP SDU from upper layers, the transmitting PDCP entity shall:

| | |
|---|---|
| - | start the discardTimer associated with this PDCU SDU (if configured) [symbol] |

For a PDCP SDU received from upper layers, the transmitting PDCP entity shall:

| | |
|---|---|
| - | associate the COUNT value corresponding to TX_NEXT to this PDCP SDU; |

NOTE 1: Associating more than half of the PDCP SN space of contiguous PDCP SDUs with PDCP SNs,
when e.g., the PDCP SDUs are discarded or transmitted without acknowledgement, may cause HFN
desynchronization problem. How to prevent HFN desynchronization problem is left up to UE implementation.

| | |
|---|---|
| - | perform header compression of the PDCP SDU using ROHC as specified in the clause 5.7.4 |

and/or using EHC as specified in the clause 5.12.4;

| | |
|---|---|
| - | perform uplink data compression of the PDCP SDU as specified in clause 5.14.4; |
| - | perform integrity protection, and ciphering using the TX_NEXT as specified in the clause 5.9 |

and 5.8, respectively;

| | |
|---|---|
| - | set the PDCP SN of the PDCP Data PDU to TX_NEXT module 2[pdcp-SN-SizeUL]; |
| - | increment TX_NEXT by one; |
| - | submit the resulting PDCP Data PDU to lower layer as specifed below. |

When submitting a PDCU PDU to lower layer, the transmitting PDCP entity shall:

| | |
|---|---|
| - | if the transmitting PDCP entity is associated with one RLC entity: |
| - | submit the PDCP PDU to the associated RLC entity: |
| - | else, if the transmitting PDCP entity is associated with at least two RLC entities: |
| - | if the PDCP duplication is activated for the RB: |
| - | if the PDCP PDU is a PDCP Data PDU: |
| - | duplicate the PDCP Data PDU and submit the PDCP Data PDU to the associated RLC entities |

activated for PDCP duplication;

| | |
|---|---|
| - | else: |
| - | submit the PDCP Control PDU to the primary RLC entity; |
| - | else (i.e. the PDCP duplication is deactivated for the RB or the RB is a DAPS bearer): |
| - | if the split secondary RLC entity is configured: and |
| - | if the total amount of PDCP data volume and RLC data volume pending for initial transmission |

(as specified in TS 38.322 [5]) in the primary RLC entity and the split secondary RLC entity is equal to or larger
than ul-DataSplitThreshold

[symbol]

| - | submit the PDCP PDU to either the primary RLC enitity or the split secondary RLC entity; | |
|---|---|---|
| - | else, if the transmitting PDCP entity is associated with the DAPS bearer: | |
| - | if the uplink data switching has not been requested: | |
| - | submit the PDCP PDU to the RLC entity associated with the source cell; | |
| - | else: | |
| - | if the PDCP PDU is a PDCP Data PDU: | |
| - | submit the PDCP Data to the RLC entity associated with the target cell: | |
| | - | else: |
| | - | if the PDCP Control PDU is associated with source cell: |
| | - | submit the PDCU Control PDU to the RLC entity associated with the source cell; |
| | - | else: |
| | - | submit the PDCU Control PDU to the RLC entity associated with the target cell; |
| | - | else: |
| | - | submit the PDCP PDU to the primary RLC entity. |

NOTE 2: If the transmitting PDCP entity is associated with two RLC entities, the UE should minimize

the amount of PDCP PDUs submitted to lower layers before receiving request from lower layers and minimize the
PDCP SN gap between PDCP PDUs submitted to two associated RLC entities to minimize PDCP reordering delay
in the receiving PDCP entity. [symbol]
indicates data missing or illegible when filed

In operation 560, the PDCP transmission entity may identify a PDCP SDU discard condition. When the discardTimer started in operation 531 expires or when it is identified that transmission of the PDCP SDU is successfully performed via a PDCP status report, the PDCP transmission entity may determine that the PDCP SDU discard condition is satisfied and may proceed with operation 570 and may discard the PDCP SDU. In addition, when at least one case is satisfied among the case in which at least one PDU set or PDU needs to be discarded based on PDU set importance, the case in which one or more PDUs (PDCP SDUs) included in a PDU set does not satisfy a PSDB (PDU set delay budget) of a QoS flow in which the PDU set is transmitted, the case in which a PDU set discardTimer related to a PSDB expires, or the case in which one or more PDU sets or one or more PDUs need to be discarded in a congestion situation based on PDU set importance and/or a PDU set size, the PDCP transmission entity may determine that the PDCP SDU discard condition is satisfied and proceed with operation 570, and may discard one or more PDCP SDU included in one or more PDU sets.

In operation 580, the PDCP transmission entity may identify whether the PDCP SDU discarded in operation 570 is transferred to the lower layer in the form of a PDCP PDU in operation 550. When the discarded PDCP SDU is transferred to the lower layer in operation 550, the PDCP transmission entity may indicate discarding of the PDCP PDU to the lower layer (one or more RLC entities) to which the corresponding PDCP SDU is transferred, in operation 590. Operations 560, 570, 580, and 590 may be based on the example in Table 3.

```
TABLE 3
  5.3 SDU discard
  When the discardTimer expires for a PDCP SDU, or the successful delivery of a PDCP SDU is confirmed
by PDCP status report, the tramsmitting PDCP entity shall discard the PDCP SDU alone with the corresponding
PDCP Data PDU. If the corresponding PDCP Data PDU has already been submitted to lower layers, the discard is
indicated to lower layers.
  For SRBs, when upper layers request a PDCP SDU discard, she PDCP entity shall discard all stored
PDCP SDUs and PDCP PDUs.
  NOTE: Discarding a PDCP SDU already associated with a PDCP SN causes a SN gap in the
transmitted PDCP Data PDUs, which increases PDCP reordering delay in the receiving PDCP entity. It is up to UE
implementation how to minimize SN gap after SDU discard.
```

A PDCP SDU discard operation may more frequently occur in a congestion situation in order to satisfy traffic (e.g., extended reality (XR) traffic) with strict Qos requirements and/or to satisfy QoS, and many PDCP SDUs may be discarded when discarding is indicated in units of PDU sets. An example of XR traffic may be shown in FIG. 4.

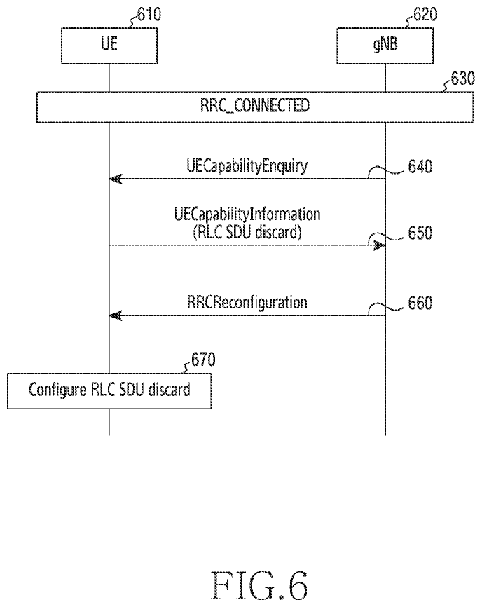

FIG. 6 is a flowchart illustrating a process in which a base station configures RLC service data unit discarding for a UE according to various embodiments of the disclosure.

Referring to FIG. 6, a UE 610 may be in an RRC connected mode (RRC_CONNECTED) 630 by establishing an RRC connection with a base station 620.

In operation 640, the base station 620 may transmit, to the UE 610, a UE capability request message (UECapabilityEnquiry) that requests reporting of capability. The UE 610 may transmit a UE capability information message ((UECapability Information) to the base station 620. The UE capability information message may include information indicating whether capability of discarding an RLC SDU transmitted to a lower layer (e.g., enhanced RLC SDU discard) is supported. The information indicating whether the capability is supported may be applied to all RLC entities of the UE or may be applied to an acknowledge mode (AM) and/or unacknowledged mode (UM), or may be applied to a length (6 bit, 12 bit, or 18 bit) of an RLC SN and may be denoted by a combination of at least one of them. An example of the information indicating whether UE capability is supported, which is included in the UE capability information message, may be as shown in Table 4.

TABLE 4
enhancedRlcSduDiscard: A transmitting side of an RLC of a UE is capable of
discarding an RLC SDU transmitted to a lower layer, and/or informing a peer RLC
entity of an RLC SN of the discarded RLC SDU, and/or a receiving side of the RLC
of the UE is capable of processing the RLC SN of the discarded RLC SDU.
am-EnhancedRlcSduDiscard: A transmitting side of an AM RLC of a UE is capable
of discarding an RLC SDU transmitted to a lower layer, and/or informing a peer
RLC entity of an RLC SN of the discarded RLC SDU, and/or a receiving side of
the AM RLC of the UE is capable of processing the RLC SN of the discarded RLC
SDU.
um-EnhancedRlcSduDiscard: A transmitting side of a UM RLC of a UE is capable
of discarding an RLC SDU transmitted to a lower layer, and/or informing a peer
RLC entity of an RLC SN of the discarded RLC SDU, and/or a receiving side of
the UM RLC of the UE is capable of processing the RLC SN of the discarded RLC
SDU.
am-EnhancedRlcSduDiscard-WithShortSN: A transmitting side of a UE's AM
RLC, configured with a 12-bit SN, is capable of discarding an RLC SDU
transmitted to a lower layer, and/or informing a peer RLC entity of an RLC SN of
the discarded RLC SDU, and/or a receiving side of the AM RLC of the UE is
capable of processing the RLC SN of the discarded RLC SDU.
am-EnhancedRlcSduDiscard-WithLongSN: A transmitting side of a UE's AM
RLC, configured with a 18-bit SN, is capable of discarding an RLC SDU
transmitted to a lower layer, and/or informing a peer RLC entity of an RLC SN of
the discarded RLC SDU, and/or a receiving side of the AM RLC of the UE is
capable of processing the RLC SN of the discarded RLC SDU.
um-EnhancedRlcSduDiscard-WithShortSN: A transmitting side of a UE's UM
RLC, configured with a 6-bit SN, is capable of discarding an RLC SDU transmitted
to a lower layer, and/or informing a peer RLC entity of an RLC SN of the discarded
RLC SDU, and/or a receiving side of the UM RLC of the UE is capable of
processing the RLC SN of the discarded RLC SDU.
um-EnhancedRlcSduDiscard-WithLongSN: A transmitting side of a UE's UM
RLC, configured with a 12-bit SN, is capable of discarding an RLC SDU
transmitted to a lower layer, and/or informing a peer RLC entity of an RLC SN of
the discarded RLC SDU, and/or a receiving side of the UM RLC of the UE is
capable of processing the RLC SN of the discarded RLC SDU.

In operation 650, the base station 620 may transfer, to the UE 610, a cell for transmitting and/or receiving user data, for example, one or more cell groups and cell configuration included in the one or more cell groups, via RRC signaling (e.g., RRCReconfiguration). In addition, the base station 620 may transfer at least one of QoS flow information, SDAP, DRB, or PDCP configuration, which is associated with a PDU session, to the UE 610 via RRC signaling. In addition, the base station 620 may transfer, to the UE 610 via RRC signaling, one or more RLC configurations for serving DRB transmission. The base station 620 may transfer, to the UE 610 via RRC signaling, an indicator (e.g., enhancedRlcSduDiscard) for configuring discarding of the RLC SDU, transmitted to the lower layer, in at least one method of configuring for each cell group, for each cell, for each PDU session, for each QoS flow, for each DRB, for each PDCP, or for each RLC. In the case of configuring discarding of the RLC SDU transmitted to the lower layer for each cell group, the indicator may be included in CellGroupConFIG. In the case of configuring for each cell, the indicator may be included in SPCellConfig and/or SCellConFIG. In the case of configuring for each PDU session or QoS flow, the indicator may be included in SDAP-ConFIG. In the case of configuring for each DRB, the indicator may be included in DRB-ToAddMod. In the case of configuring for each PDCP, the indicator may be included in pdcp-ConFIG. In the case of configuring for each RLC, the indicator may be included in RLC-BearerConfig and/or RLC-ConFIG. Information transferred via RRC signaling may be as shown in the example in Table 5.

```
TABLE 5
  RRCReconfiguration ::= SEQUENCE {
    rrc-TransactionIdentifier RRC-TranscriptionIdentifier,
    criticalExtensionsFuture CHOICE {
    rrcReconfiguration  RRCReconfiguration-IEs,
    criticalExtensionsFuture SEQUENCE { }

[symbol]

  RRCReconfiguration-IEs ::″ SEQUENCE {

[symbol]

OPTIONAL,
    nonCriticalExtension [symbol]   Reconfiguration-v1530-IEs
OPTIONAL

[symbol]

  RRCReconfiguration-v1530-IEs ::= SEQUENCE {
    masterCellGroup OCTET STRING (CONTAINING CellGroupConfig)
OPTIONAL, --Need M
    fullConfig ENUMERATED (true)
OPTIONAL, -- Cond FullConfig
    dedicatedNAS- [symbol]
Message OPTIONAL, -- Cond [symbol]
    masterKeyUpdate MasterKeyUpdate
OPTIONAL, -- Cond MasterKeyChange
    dedicated [symbol]   -Delivery OCTET STRING (CONTAINING [symbol]    )
OPTIONAL, --Need [symbol]
    dedicatedSystemInformationDelivery OCTET STRING (CONTAINING SystemInformation)
OPTIONAL, --Need [symbol]
    otherConfig OtherConfig
OPTIONAL, --Need M
    nonCriticalExtension [symbol]   Reconfiguration-v1540-IEs
OPTIONAL

[symbol]

  RRCReconfiguration-v1540-IEs ::= SEQUENCE {
    otherConfig-v1540 OtherConfig-v1540
OPTIONAL, --Need M
    nonCriticalExtension RRCReconfiguration-v1560-IEs
OPTIONAL

[symbol]

  RRCReconfiguration-v1560-IEs ::= SEQUENCE { [symbol]
    -SecondaryCellGroupConfig SetupRelease [symbol]
SecondaryCellGroupConfig [symbol]    OPTIONAL, --Need N
    r [symbol]   OCTET STRING (CONTAINING radio [symbol]   rerConfig)
OPTIONAL, --Need M
    sk-Counter SK-Counter
OPTIONAL, --Need N
    nonCriticalExtension RRCReconfiguration-v1610-IEs
OPTIONAL

[symbol]

  RRCReconfiguration-v1610-IEs ::= SEQUENCE {
    otherConfig-1610 OtherConfig-1610
OPTIONAL, --Need M [symbol]
  -Config-r16 [symbol]
OPTIONAL, --Need M
    iab-IP-AddressConfigurationList-r16 IAB-IP-AddressConfigurationList-r16
OPTIONAL, --Need [symbol]
    conditionalReconfiguration-r16 ConditionalReconfiguration-r16
OPTIONAL, --Need M

[symbol]

OPTIONAL, --Need [symbol]
    dedicatedPosSysInfoDelivery-r16 OCTET STRING(CONTAINING
PosSystemInformation-r16-IEs) OPTIONAL, -- Need N
    si-ConfigDedicatedNR-r16 SetupRelease {SL-ConfigDedicatedNR-r16}
OPTIONAL, --Need M
    si-ConfigDedicatedEUTRA-Info-r16 SetupRelease (SL-ConfigDedicatedEUTRA-Info-
r16) OPTIONAL, --Need [symbol]
    targetCellSMTC-S [symbol]
OPTIONAL, --Need [symbol]
    nonCriticalExtension [symbol]
OPTIONAL

[symbol]

  RRCReconfiguration-v1700-IEs ::= SEQUENCE {
    otherConfig-v1700 OtherConfig-v1700
OPTIONAL, --Need M
    sl-L2 [symbol]   layUE-Config-r17 SetupRelease ( SL-L2RelayUE-Config-r17 )
OPTIONAL, --Need M
    sl-L2RemoteUE-Config-r17 SetupRelease ( SL-L2RemoteUE-Config-r17 )
OPTIONAL, --Need [symbol]
    dedicatedPagingDelivery-r17 OCTET STRING (CONTAINING Paging)
OPTIONAL, -- Cond PagingRelay
    needForGap [symbol]   -ConfigNR-r17 SetupRelease (NeedforGap [symbol]   -ConfigNR-r17)
OPTIONAL, --Need M
    needForGap [symbol]   -ConfigEUTRA-r17 SetupRelease (NeedforGapNSC [symbol]   -ConfigEUTRA-r17)
OPTIONAL, --Need M [symbol]
    im-GapConfig-r17 SetupRelease ( [symbol]   -GapConfig-r17)
OPTIONAL, --Need [symbol] [symbol]
    -Config-r17 SetupRelease [symbol]
OPTIONAL, --Need M
    scg-State-r17 ENUMERATED ( deactivated )
OPTIONAL, --Need N
    sppLayerMeasConfig-r17 AppLayerMeasConfig-r17
OPTIONAL, --Need M [symbol]
    -RequestUL-TDOA-Config-r17 SetupRelease ( [symbol]   -RequestUL-TDOA-
Config-r17) OPTIONAL, --Need M
    nonCriticalExtension SEQUENCE [symbol]
OPTIONAL

[symbol]

[symbol]

    -SecondaryCellGroupConfig ::= SEQUENCE { [symbol]
    Add ENUMERATED ( true )
OPTIONAL, --Need [symbol] [symbol]
    -SecondaryCellGroup CHOICE {
      nr-SCS OCTET STRING (CONTAINING RRCConfiguration), [symbol]
      -SCS OCTET STRING

[symbol]

[symbol]

    AF-Config-r16 ::= SEQUENCE {
    cap-Address-r16 STT STRING (SIZE ( [symbol]   ))
OPTIONAL, --Need M
    defaultUL-BA [symbol]   -RoutingID-r16 BA [symbol]   -RoutingID-r16
OPTIONAL, --Need [symbol]
    defaultUL- [symbol]   -RLC-Channel-r16 [symbol]   -RLC-Channel-r16
OPTIONAL, --Need M
    flowControlFeedbackType-r16 ENUMERATED (per [symbol]
both) OPTIONAL, --Need [symbol]
    ...

[symbol]

  MasterKeyUpdate ::= SEQUENCE {
    KeySetChangeIndicator BOOLEAN,
    nextHopChainingCount NextHopChainingCount, [symbol]
    -Container OCTET  STRING
OPTIONAL, -- Cond security [symbol]   ,
    ...

[symbol]

  OnDemandSIB-Request-r16 ::= SEQUENCE {
    onDemandSIB-Request [symbol]   Timer-r16 ENUMERATED { [symbol]   , s1, s2, s5, s10,
s20, s30}

[symbol]

[symbol]

  316-r16 ::= ENUMERATED [symbol]    ms50, ms100, ms200, ms300, ms400, ms500, ms600, ms1000,
ms1500, ms2000 [symbol]
  IAB-IP-AddressConfigurationList-r16 ::= SEQUENCE {
    iab-IP-AddressToAddModList-r16 SEQUENCE (SIZE(1..maxIAB-IP-Address-r16)) OF IAB-
IP-AddresConfiguration-r16 OPTIONAL, -- Need [symbol]
    iab-IP-AddressToReleaseList-r16 SEQUENCE (SIZE(1..maxIAB-IP-Address-r16)) OF IAB-
IP-AddresIndex-r16  OPTIONAL, -- Need [symbol]
  ...

[symbol]

  IAB-IP-AddressConfiguration-r16 ::= SEQUENCE {
    iab-IP-AddressIndex-r16 IAB-IP-AddressIndex-r16,
    iab-IP-Address-r16 IAB-IP-Address-r16,
OPTIONAL, --Need M
    iab-IP-Usage-r16 IAB-IP-Usage-r16
OPTIONAL, --Need M
    iab-donor- [symbol]   -Address-r16 BIT STRING (SIZE(10))
OPTIONAL, --Need M
  ...

[symbol]

  SL-ConfigDedicatedEUTRA-Info-r16 ::= SEQUENCE {
    sl-ConfigDedicatedEUTRA-r16  OCTET STRING
OPTIONAL, --Need M
    sl-TimeOffsetEUTRA-List-r16 SEQUENCE (SIZE (6)) OF SL-
TimeOffsetEUTRA-r16 OPTIONAL, --Need M

[symbol]

  SL-TimeOffsetEUTRA-r16 ::= ENUMERATED (ms0, ms0dot25, ms0dot0, ms0dot625,
ms0dot75, ms1, ms1dot75, ms1dot5, ms1dot75,
                                        ms2, ms2dot5, ms3, ms4, ms5, ms6, ms8, ms10, ms20) [symbol]
  -RequestUL- [symbol]   A-Config-r17 ::= CHOICE {
    oneShot-r17 NULL,
    periodicRequesting-r17 ENUMERATED ( ms160, ms320, ms1280, ms2560,
ms61440, ms81920, ms368640, ms737280 )

[symbol]

  CellGroupConfig ::= SEQUENCE {
    cellGroupId CellGroupId,
    rlc-BearerToAddModList SEQUENCE (SIZE(1..maxLC-ID)) OF RLC-
BearerConfig OPTIONAL, --Need M
    rlc-BearerToReleaseList SEQUENCE (SIZE(1..maxLC-ID)) OF
LogicalChannelIdentity OPTIONAL, --Need [symbol]
    mac-CellGroupConfig MAC-CellGroupConfig
OPTIONAL, --Need [symbol]
    physicalCellGroupConfig PhysicalCellGroupConfig
OPTIONAL, --Need [symbol]
    spCellConfig SpCellConfig
OPTIONAL, --Need M
    sCellToAddModList SEQUENCE (SIZE (1..maxNrofSCells)) OF
SCellConfig OPTIONAL, --Need N
    sCellToReleaseList SEQUENCE (SIZE (1..maxNrofSCells)) OF
SCellConfig OPTIONAL, --Need N
    ...,

[symbol]

    reportUplink [symbol]   DirectCurrent ENUMERATED {true}
OPTIONAL  -- Cond [symbol]    -Reconfig

[symbol]

    b [symbol]   p-Address-r16 BIT STRING (SIZE (10))
OPTIONAL, --Need [symbol]
    bh-RLC-ChannelToAddModList-r16 SEQUENCE (SIZE (1..maxBH-RLC-ChannelID-
r16)) OF BH-RLC-ChannelConfig-r16 OPTIONAL, -- Need [symbol]
    bh-RLC-ChannelToReleaseList-r16 SEQUENCE (SIZE (1..maxBH-RLC-ChannelID-
r16)) OF BH-RLC-ChannelID-r16 OPTIONAL, -- Need [symbol]
    rlc-TransaferPath-r16 ENUMERATED ( [symbol]   , both)
OPTIONAL, --Need M
    simultaneousTCI-UpdateList1-r16 SEQUENCE (SIZE (1..maxNrofServingCellsTCI-
r16)) OF ServCellIndex OPTIONAL, -- Need [symbol]
    simultaneousTCI-UpdateList2-r16 SEQUENCE (SIZE (1..maxNrofServingCellsTCI-
r16)) OF ServCellIndex OPTIONAL, -- Need [symbol]
    simultaneousSpatial-UpdateList1-r16 SEQUENCE (SIZE (1..maxNrofServingCellsTCI-
r16)) OF ServCellIndex OPTIONAL, -- Need [symbol]
    simultaneousSpatial-UpdateList2-r16 SEQUENCE (SIZE (1..maxNrofServingCellsTCI-
r16)) OF ServCellIndex OPTIONAL, -- Need R
    uplink [symbol]   Option-r16 ENUMERATED [symbol]    switchedUL, custUL [symbol]
OPTIONAL, -- Need R
    uplink [symbol]   SwitchingPowerBoosting-r16 ENUMERATED [symbol]    enabled [symbol]
OPTIONAL, -- Need

[symbol]

[symbol]

    reportUplink [symbol]   DirectCurrentTwoCarrier-r16 ENUMERATED  (true)
OPTIONAL, -- Need M

[symbol]

    fl [symbol]   -Transfer [symbol]   C-r17 ENUMERATED [symbol]
OPTIONAL, -- Need M
    uplink [symbol]   Switching- [symbol]   -r17 ENUMERATED [symbol]    enabled [symbol]
OPTIONAL, -- Cond [symbol]
    uplink [symbol]   Switching- [symbol]   tate-r17 ENUMERATED [symbol]    oneT, twoT [symbol]
OPTIONAL, -- Cond [symbol]
    uu-RelayRLC-ChannelToAddModListr17 SEQUENCE (SIZE (1..maxUu-RelayRLC-
ChannelID-r17)) OF Uu-RelayRLC-ChannelConfig-r17
OPTIONAL, -- Need N
    simultaneous [symbol]
r16)) OF ServCellIndex OPTIONAL, -- Need R
    simultaneous [symbol]
r16)) OF ServCellIndex OPTIONAL, -- Need [symbol]
    simultaneous [symbol]
r16)) OF ServCellIndex OPTIONAL, -- Need [symbol]
    simultaneous [symbol]
r16)) OF ServCellIndex OPTIONAL, -- Need R
    rlc-s [symbol]
LogicalChannelIdentityExt-r17 OPTIONAL, -- Need N

[symbol]

OF IAB-ResourceConfig-r17 OPTIONAL, -- Need N

[symbol]

r17)) OF IAB-

[symbol]

[symbol]

r17 OPTIONAL, -- Need N

[symbol]

[symbol]

  Serving cell specific MAC and [symbol]     parameters for a [symbol]
  SpCellConfig ::= SEQUENCE [symbol]
    servCellIndex ServCellIndex
OPTIONAL, -- Cond [symbol]
    reconfigurationWithSync ReconfigurationWithSync
OPTIONAL, -- Cond

[symbol]

[symbol]

OPTIONAL, -- Need M

[symbol]

OPTIONAL, -- Need [symbol]
    spCellConfigDedicated ServingCellConfig
OPTIONAL, -- Need [symbol]
    ...,

[symbol]

spare2, spare1),

[symbol]

OPTIONAL, -- Need R

[symbol]

OPTIONAL, -- Need R

[symbol]

OPTIONAL, -- Need

[symbol]

[symbol]

OPTIONAL, -- Cond

[symbol]

[symbol]

  ReconfigurationWithSync ::= SEQUENCE [symbol]
    spCellConfigCommon ServingCellConfigCommon

[symbol]

OPTIONAL, -- Need

[symbol]

[symbol]

OPTIONAL, -- Need

[symbol]

[symbol]

OPTIONAL, -- Need

[symbol]

[symbol]

OPTIONAL, -- Cond

[symbol]

[symbol]

OPTIONAL, -- Cond

[symbol]

[symbol]

OPTIONAL, -- Need N

[symbol]

OPTIONAL, -- Need N

[symbol]

OPTIONAL, -- Cond

[symbol]

[symbol]

OPTIONAL, -- Cond

[symbol]

[symbol]

OPTIONAL, -- Need M

[symbol]

OPTIONAL, -- Need

[symbol]

[symbol]

OPTIONAL, -- Need [symbol]
    ...,

[symbol]

OPTIONAL, -- Need R

[symbol]

OPTIONAL, -- Need R

[symbol]

OPTIONAL, -- Cond

[symbol]

[symbol]

  ReconfigurationWithSync ::= SEQUENCE [symbol]
    spCellConfigCommon ServingCellConfigCommon

[symbol]

OPTIONAL, -- Need

[symbol]

[symbol]

OPTIONAL, -- Need [symbol]
    ...,

[symbol]

ServeCellIndex,
    ccCombinationList-r17 SEQUENCE (SIZE(1.. maxNrofReqco [symbol]
r17)) OF Intra

[symbol]

[symbol]

  CarrierState-r17::= CHOICE {
    deActivated-r17 NULL,

[symbol]

OPTIONAL, -- Need N

[symbol]

OPTIONAL, -- Need N
    ...

[symbol]

  RadioBearerConfig ::= SEQUENCE {

[symbol]

OPTIONAL, -- Cond

[symbol]

[symbol]

OPTIONAL, -- Need [symbol]
    drb-ToAddModList DRB-ToAddModList
OPTIONAL, -- Cond

[symbol]

[symbol]

OPTIONAL, -- Need

[symbol]

[symbol]

OPTIONAL, -- Need M
  ...,

[symbol]

    srb-Identity SRB-Identity,

[symbol]

OPTIONAL, -- Need M
    pdcp-Config PDCP-Config
OPTIONAL, -- Cond PDCP
    ...,

[symbol]

    srb-Identity-v1700 SRB-Identity-v1700
OPTIONAL, -- Need M

[symbol]

OPTIONAL, -- Cond PDCP
    ...,

[symbol]

  SecurityConfig::= SEQUENCE {
    securityAlgorithmConfig SecurityAlgorithmConfig
OPTIONAL, -- Cond

[symbol]

[symbol]

OPTIONAL, -- Need N
    reestabilshPDCP=r17 ENUMERATED

[symbol]

[symbol]

OPTIONAL, -- Cond PDCP
  ...

[symbol]

    discardTimer ENUMERATED [symbol]    ms10, ms20, ms30, ms40, ms50, ms60, ms75,
ms100, ms150, ms200,
                                        ms250, ms300, ms500, ms750, ms1 [symbol]
OPTIONAL, -- Cond Setup

[symbol]

OPTIONAL, -- Cond Setup1

[symbol]

OPTIONAL, -- Cond Setup2
      headerCompression CHOICE [symbol]
        notUsed NULL,

[symbol]

          profile0x0001 BOOLEAN,
          profile0x0002 BOOLEAN,
          profile0x0003 BOOLEAN,
          profile0x0004 BOOLEAN,
          profile0x0006 BOOLEAN,
          profile0x0101 BOOLEAN,
          profile0x0102 BOOLEAN,
          profile0x0103 BOOLEAN,
          profile0x0104 BOOLEAN

[symbol]

OPTIONAL -- Need N

[symbol]

          profile0x0006 BOOLEAN

[symbol]

OPTIONAL -- Cond ConnectedTo

[symbol]

[symbol]

OPTIONAL -- Need N
    rlc-Config RLC-Config
OPTIONAL -- Cond LCH-Setup [symbol]
    -LogicalChannelConfig LogicalChannelConfig
OPTIONAL -- Cond LCH-Setup
    ...,

[symbol]

    rlc-Config-v1610 RLC-Config-v1610
OPTIONAL -- Need R

[symbol]

OPTIONAL -- Need R
    logicalChannelIndetityExt-r17 LogicalChannelIdentityExt-r17

[symbol]

  DL-AM-REC-v1610 ::= SEQUENCE [symbol]
    t-StatusProhibit-v1610 T-StatusProhibit-v1610
OPTIONAL , -- Need N
    ...

[symbol]

    t-ReassemblyExt-r17 T-ReassemblyExt-r17
OPTIONAL -- Need

[symbol]

[symbol]

    t-ReassemblyExt-r17 T-ReassemblyExt-r17
OPTIONAL -- Need W

[symbol]

spare2, spare1 [symbol]
  T-ReassemblyExt-r17 ::= ENUMERATED [symbol]     ms210, ms220, ms340, ms350, ms550,
ms1100, ms1650, ms2200 [symbol] [symbol]
indicates data missing or illegible when filed
```

In operation 660, when the indicator for configuring discarding of the RLC SDU transmitted to the lower layer is included in the configuration received via RRC signaling transmitted in operation 650, the UE 610 may perform at least one of an operation of discarding the RLC SDU transmitted to the lower layer and an operation of informing a peer RLC entity of an RLC SN of the discarded SDU, in at least one of all RLC transmitting sides configured in a cell group including the indicator, all RLC transmitting sides allowed to perform transmission to a cell including the indicator, all RLC transmitting sides for serving transmission of a DRB mapped to a QoS flow including the indicator, all RLC transmitting sides for serving transmission of a DRB including the indicator, all RLC transmitting sides for serving transmission of a DRB corresponding to a PDCP including the indicator, or a transmitting side of at least one RLC including the indicator. In addition, the receiving side of the RLC of the UE may process the RLC SN of the discarded RLC SDU.

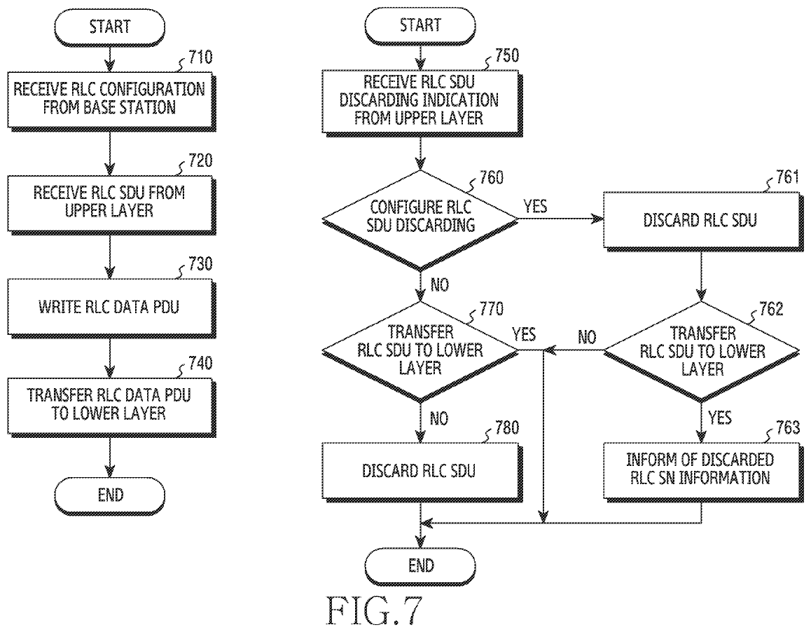

FIG. 7 is a flowchart illustrating operation of an RLC transmitting side and a service data unit discarding operation according to various embodiments of the disclosure.

Referring to FIG. 7, in operation 710, a base station may transfer, via RRC signaling, configuration information of an RLC entity for transmitting a DRB, and the configuration that may be transferred may be as shown in the example in Table 6. Transmission of the RRC signaling may be based on the example of FIG. 6.

```
TABLE 6
  RLC- [symbol]   Config ::= SEQUENCE {
    logicalChannelIdentity LogicalChannelIdentity,

[symbol]

OPTIONAL, -- Cond LCN-SetupOnly ENUMERATED (true)

[symbol]

OPTIONAL, -- Need N
    rlc-Config RLC-Config
OPTIONAL, -- Cond LCN-Setup [symbol]
    -LogicalChannelConfig LogicalChannelConfig
OPTIONAL, -- Cond LC [symbol]   -Setup
    ...,

[symbol]

OPTIONAL, -- Need

[symbol]

[symbol]

    rlc-Config-v1700 RLC-Config-v1700
OPTIONAL, -- Need [symbol]
    logicalChannelIdentity [symbol]   logicalChannelIdentity [symbol]
OPTIONAL, -- Cond L

[symbol]

[symbol]

OPTIONAL, -- Cond L

[symbol]

[symbol]

OPTIONAL, -- Need N

[symbol]

OPTIONAL, -- Need

[symbol]

[symbol]

  LogicalChannelIdentity [symbol]   INTEGER [symbol]
  RLC-Config ::= CHOICE { [symbol]
                            SEQUENCE {

[symbol]

    ...

[symbol]

OPTIONAL, -- Cond

[symbol]

[symbol]

OPTIONAL, -- Cond

[symbol]

[symbol]

OPTIONAL, -- Cond

[symbol]

[symbol]

OPTIONAL, -- Cond

[symbol]

[symbol]

    t-Reassembly T-Reassembly

[symbol]

  RLC-Config-v1610 ::= SEQUENCE {
    dl-am-rlc-v1610 DL-AM-RLC-v1

[symbol]

[symbol]

  RLC-Config-v1700 ::= SEQUENCE {
    dl-AM-RLC-v1700 DL-AM-RLC-v1700,
    dl- [symbol]   -RLC-v1700 DL-UM-RLC-v1700

[symbol]

  DL-AM-RLC-v1610 SEQUENCE {
    t-StatusProhibit-v1610 T-StatusProhibit-v1610
OPTIONAL, -- Need N
    ...

[symbol]

  DL-AM-RLC-v1700 SEQUENCE {
    t-ReassemblyExt-r17 T-ReassemblyExt-r17
OPTIONAL, -- Need N

[symbol]

  DL-UM-RLC-v1700 SEQUENCE {
    t-ReassemblyExt-r17 T-ReassemblyExt-r17
OPTIONAL, -- Need N

[symbol]

  T-StatusProhibit-v1610 ::= ENUMERATED [symbol]    , spare4, spare3,
spare2, spare1 [symbol]
  T-ReassemblyExt-r17 ::= ENUMERATED

[symbol]

[symbol]

[symbol]

indicates data missing or illegible when filed
```

In operation 720, the transmitting side of the RLC may receive a RLC SDU from an upper layer. A method in which the upper layer transmits the RLC SDU to the RLC transmitting side in the form of a PDU of the upper layer may be based on the example of FIG. 5.

In operation 730, the transmitting side of the RLC may determine, to be TX_Next, an SN of an RLC data PDU including an RLC SDU or an RLC SDU segment, and may write an RLC Data PDU. In the case of a segment, the RLC Data PDU may include at least one of segment info (SI) or segment offset (SO).

In operation 740, the transmitting side of the RLC may transmit the RLC Data PDU configured in operation 730 to a lower layer. The details of operations 730 and 740 may be based on the example in Table 7.

```
TABLE 7
      5.2.2 UM data transfer
      5.2.2.1 Transmit operations
      5.3.2.1.1  General
      When submitting a UMD PDU to lower layer, the transmitting UM RLC entity shall:
      - if the UMD PDU contains a segment of an RLC SDU, set the SN of the UMD PDU to TX_Next;
      - if the UMD PDU contains a segment than maps to the last byte of an RLC SDU, then increment
TX_Next by one.
      5.2.3 AM data transfer
      5.2.3.1 Transmit operations
      5.2.3.1.1 General
      The transmitting side of an AM RLC entity shell prioritize transmission of RLC control PDUs over AMD
previously transmitted RLC SDUs or RLC SDU segments over transmission of AMD PDUs containing not
previously transmitted RLC SDUs or RLC SDU segments.
      The transmitting side of an AM RLC entity shall maintain a transmitting window according to the state
variable TX_Next_Ack as follows:
a SN falls within the transmitting window if TX_Next_Ack <= SN < TX_Next_Ack +
AM_Window_Size;
      - a SN falls outside of the transmitting window otherwise.
      The transmitting side of an AM RLC entity shall not submit to lower layer any AMD PDU whose SN
falls outside of the transmitting window.
      For each RLC SDC received from the upper layer, the AM RLC entity shall:
      - associate a SN with the RLC SDU equal to TX_Next and construct an AMD PDU by setting
the SN of the AMD PDU to TX_Next;
      - increment TX_Next by one.
      When submitting an AMD PDU that contains a segment of an RLC SDU, to lower layer, the transmitting
side of an AM RLC entity shall:
      - set the SN of the AMD PDU to the SN of the corresponding RLC SDU.
      The transmitting side of an AM RLC entity can receive a positive acknowledgement (confirmation of
successful reception by its peer AM RLC entity) for an RLC SDU by the following:
      - STATUS PDU from its peer AM RLC entity.
      When receiving a positive acknowledgement for an RLC SDU with SN = x, the transmitting side of an
AM RLC entity shall:
      - sens an indication to the upper layers of successful delivery of the RLC SDU;
      - set TX_Next_Ack equal to the SN of the RLC SDU with the smallest SN, whose SN falls
within the range TX_Next_Ack <= SN <+ TX_Next and for which a positive acknowledgement has not been
received yet.
```

In operation 750, discarding of an RLC SDU may be indicated to the RLC from an upper layer. A method in which the upper layer indicates discarding of a PDU of the upper layer to the RLC may be based on the example of FIG. 5.

In operation 760, the transmitting side of the RLC may identify whether discarding of the RLC SDU transferred to the lower layer is configured. A method of configuring discarding of the RLC SDU transferred to the lower layer may be based on the example of FIG. 6. When discarding of the RLC SDU transferred to the lower layer is configured, the transmitting side of the RLC may proceed with operation 761. When discarding of the RLC SDU transferred to the lower layer is not configured, the transmitting side of the RLC may proceed with operation 770.

In operation 761, the transmitting side of the RLC may discard the RLC SDU indicated by the upper layer.

In operation 762, the transmitting side of the RLC may identify whether the RLC SDU and/or RLC SDU segment of which discarding is indicated is transferred to the lower layer in the form of the RLC data PDU in operation 740. When the RLC SDU and/or RLC SDU segment of which discarding is indicated is transferred to the lower layer in operation 740, the transmitting side of the RLC may proceed with operation 763.

In operation 763, the transmitting side of the RLC may inform a peer RLC entity that the RLC SDU transferred to the lower layer is discarded, in the form of an RLC UDM PDU, and/or RLC AMD PDU, and/or RLC CONTROL PDU.

In operation 770, the transmitting side of the RLC may identify whether the RLC SDU and/or RLC SDU segment of which discarding is indicated is transferred to the lower layer in the form of the RLC data PDU in operation 740. When the RLC SDU and/or RLC SDU segment of which discarding is indicated is transferred to the lower layer in operation 740, the transmitting side of the RLC may not discard the RLC SDU of which discarding is indicated. When the RLC SDU and/or RLC SDU segment of which discarding is indicated is not transferred to the lower layer, the transmitting side of the RLC may discard the RLC SDU of which discarding is indicated.

The details of operations 750, 760, 770, and 780 may be based on the example in Table 8.

```
TABLE 8
      - SDU discard procedures
      When indicated from upper layer (i.e. PDCP) to discard a particular
RLC SDU, the transmitting side of an AM RLC entity or the transmitting
UM RLC entity shall discard the indicated RLS SDU, if neither the RLC
SDU nor a segment thereof has been submitted to the lower layers. The
transmitting side of an AM RLC entity shall not introduce an RLC SN
gap when discarding an RLC SDU.
```

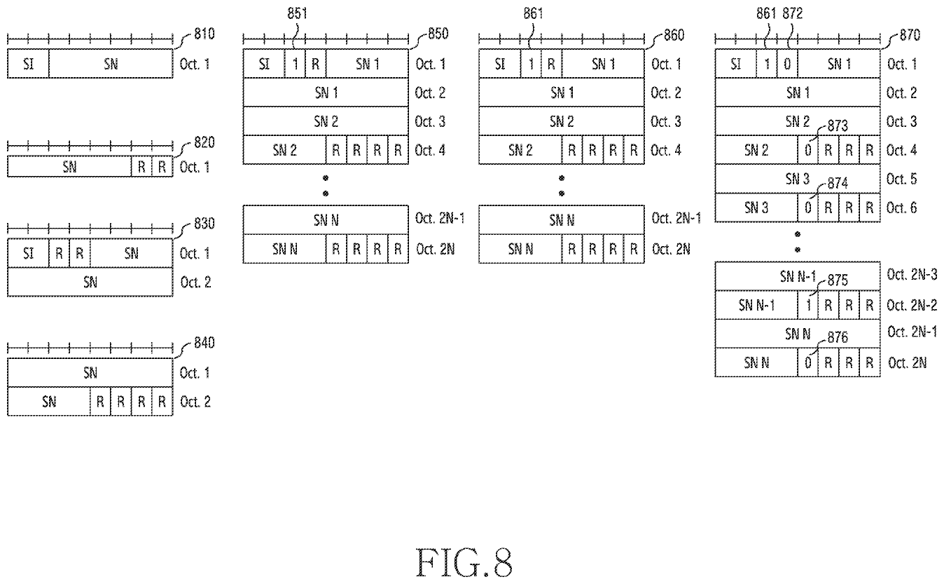

FIG. 8 is a diagram illustrating a method of informing a peer RLC of a discarded RLC SN in the form of a UMD PDU according to various embodiments of the disclosure.

Referring to FIG. 8, when an RLC SDU transmitted to at least one lower layer is discarded, a transmitting side of a UM RLC may inform a peer RLC of the at least one discarded RLC SN in the form of a UMD PDU. A method of discarding the RLC SDU transmitted to the lower layer may be based on the example of FIG. 7.

The UM RLC may be configured to use a 6-bit SN. The transmitting side of the UM RLC may generate a UMD PDU 810 with a 1-byte length including the discarded RLC SN, and may transfer the UMD PDU 810 to the peer RLC so as to inform of the discarded RLC SN. The transmitting side of the UM RLC may indicate the discarded RLC SN irrespective of an SI value, or may configure an SI value to at least one of 00, 01, 10, and 11 so as to indicate the discarded RLC SN. When the UMD PDU 810 with a 1-byte length is received, a receiving side (receiving part) of the peer UM RLC may determine that it indicates the discarded RLC SN. The receiving side of the peer UM RLC may determine that it indicates the discarded RLC SN irrespective of the SI value, or when the SI value is at least one of 00, 01, 10, or 11, may determine that it indicates the discarded RLC SN.

The UM RLC may be configured to use a 6-bit SN. The transmitting side of the UM RLC may generate a UMD PDU 820 with a 1-byte length including the discarded RLC SN, and may transfer the UMD PDU 820 to the peer RLC so as to inform of the discarded RLC SN. When the UMD PDU 820 with a 1-byte length is received, the receiving side of the peer UM RLC may determine that it indicates the discarded RLC SN. An R bit may be configured to a value of 0, and when another value is included, the receiving side of the RLC may disregard the corresponding value or may regard the RLC PDU as invalid and may discard the same.

The UM RLC may be configured to use a 12-bit SN. The transmitting side of the UM RLC may generate a UMD PDU 830 with a 2-byte length including the discarded RLC SN, and may transfer the UMD PDU 830 to the peer RLC so as to inform of the discarded RLC SN. The transmitting side of the UM RLC may indicate the discarded RLC SN irrespective of an SI value, or may configure an SI value to at least one of 00, 01, 10, and 11 so as to indicate the discarded RLC SN. When the UMD PDU 830 with a 2-byte length is received, the receiving side of the peer UM RLC may determine that it indicates the discarded RLC SN. The receiving side of the peer UM RLC may determine that it indicates the discarded RLC SN irrespective of the SI value, or when the SI value is at least one of 00, 01, 10, or 11, may determine that it indicates the discarded RLC SN. An R bit may be configured to a value of 0, and when another value is included, the receiving side of the RLC may disregard the corresponding value or may regard the RLC PDU as invalid and may discard the same.

The UM RLC may be configured to use a 12-bit SN. The transmitting side of the UM RLC may generate a UMD PDU 840 with a 2-byte length including the discarded RLC SN, and may transfer the UMD PDU 840 to the peer RLC so as to inform of the discarded RLC SN. When the UMD PDU 840 with a 2-byte length is received, the receiving side of the peer UM RLC may determine that it indicates the discarded RLC SN. An R bit may be configured to a value of 0, and when another value is included, the receiving side of the RLC may disregard the corresponding value or may regard the RLC PDU as invalid and may discard the same.

The UM RLC may be configured to use a 12-bit SN. The transmitting side of the UM RLC may configure a 3^{rd} bit 851 to 1, may generate a UMD PDU 850 with a 2-byte or more length including the discarded RLC SN, and may transfer the same to the peer RLC so as to inform of the discarded RLC SN. The transmitting side of the UM RLC may indicate the discarded RLC SN irrespective of an SI value, or may configure an SI value to at least one of 00, 01, 10, and 11 so as to indicate the discarded RLC SN. When the UMD PDU 850 with the 3^{rd} bit 851 configured to 1 is received, the receiving side of the peer UM RLC may determine that it indicates the discarded RLC SN. The discarded RLC SN may be included in ascending order. The receiving side of the peer UM RLC may determine a value obtained by dividing the byte length of the UMD PDU 850 by 2, to be the number of discarded RLC SNs included in the UMD PDU 850. The receiving side of the peer UM RLC may determine that it indicates the discarded RLC SN irrespective of the SI value, or when the SI value is at least one of 00, 01, 10, or 11, may determine that it indicates the discarded RLC SN. An R bit may be configured to a value of 0, and when another value is included, the receiving side of the RLC may disregard the corresponding value or may regard the RLC PDU as invalid and may discard the same.

The UM RLC may be configured to use a 12-bit SN. The transmitting side of the UM RLC may configure a 3^{rd} bit 861 to 1, may generate a UMD PDU 860 with a 4-byte or more length including the discarded RLC SN, and may transfer the UMD PDU 860 to the peer RLC so as to inform of the discarded RLC SN. The transmitting side of the UM RLC may indicate the discarded RLC SN irrespective of an SI value, or may configure an SI value to at least one of 00, 01, 10, and 11 so as to indicate the discarded RLC SN. The transmitting side of the UM RLC includes two RLC SNs for every 4 octet units, and may indicate that consecutive RLC SNs from a first RLC SN or higher and a second RLC SN or lower are discarded. The discarded RLC SN may be included in ascending order. When the UMD PDU 860 with the 3^{rd} bit 861 configured to 1 is received, the receiving side of the peer UM RLC may determine that it indicates the discarded RLC SN. The receiving side of the peer UM RLC may determine that it indicates the discarded RLC SN irrespective of the SI value, or when the SI value is at least one of 00, 01, 10, or 11, may determine that it indicates the discarded RLC SN. The receiving side of the peer UM RLC may determine a value obtained by dividing the byte length of the UMD PDU 860 by 2, to be the number of discarded RLC SNs included in the UMD PDU 860. With respect to two RLC SNs that may be included for every 4 octet units, the receiving side of the peer UM RLC may determine that consecutive RLC SNs from a first RLC SN or higher and a second RLC SN or lower are discarded. An R bit may be configured to a value of 0, and when another value is included, the receiving side of the RLC may disregard the corresponding value or may regard the RLC PDU as invalid and may discard the same.

The UM RLC may be configured to use a 12-bit SN. The transmitting side of the UM RLC may configure a 3^{rd} bit 871 to 1, may generate a UMD PDU 870 with a 2-byte or more length including the discarded RLC SN, and may transfer the UMD PDU 870 to the peer RLC so as to inform of the discarded RLC SN. The transmitting side of the UM RLC may indicate the discarded RLC SN irrespective of an SI value, or may configure an SI value to at least one of 00, 01, 10, and 11 so as to indicate the discarded RLC SN. The transmitting side of the UM RLC may configure, to 1, a 4^{th} bit 872 of a first octet or 5^{th} bits 873, 874, 875, and 876 of even numbered octets whose octet numbers are greater than or equal to 4, and may indicate that consecutive RLC SNs from a first RLC SN or higher and a second RLC SN or lower are discarded via two RLC SNs that may be included in two octet units configured to 1 and two subsequent octet units. The discarded RLC SNs may be included in ascending order, and may be represented by combining a single value or consecutive values. When the UMD PDU 870 in which the 3^{rd} bit 871 of the first octet is configured to 1, and the SI value is configured to at least one of 00, 01, 10, or 11, or the 4^{th} bit 872 of the first octet or 5^{th} bits 873, 874, 875, and 876 of the even numbered octets whose octet numbers are greater than or equal to 4 are configured to 0, is received, the receiving side of the peer UM RLC may determine that the 2 octet units configured to 0 indicate a single discarded RLC SN. When the 3^{rd} bit 871 of the first octet is configured to 1, and the SI value is configured to at least one of 00, 01, 10, or 11, or the 4^{th} bit 872 of the first octet or 5^{th} bits 873, 874, 875, and 876 of the even numbered octets whose octet numbers are greater than or equal to 4 are configured to 1, the receiving side of the peer UM RLC may determine that consecutive RLC SNs from a first RLC SN or higher and a second RLC SN or lower are discarded in association with two RLC SNs that may be included in the 2 octet units configured to 1 and the 2 subsequent octet units indicate. An R bit may be configured to a value of 0, and when another value is included, the receiving side of the RLC may disregard the corresponding value or may regard the RLC PDU as invalid and may discard the same.

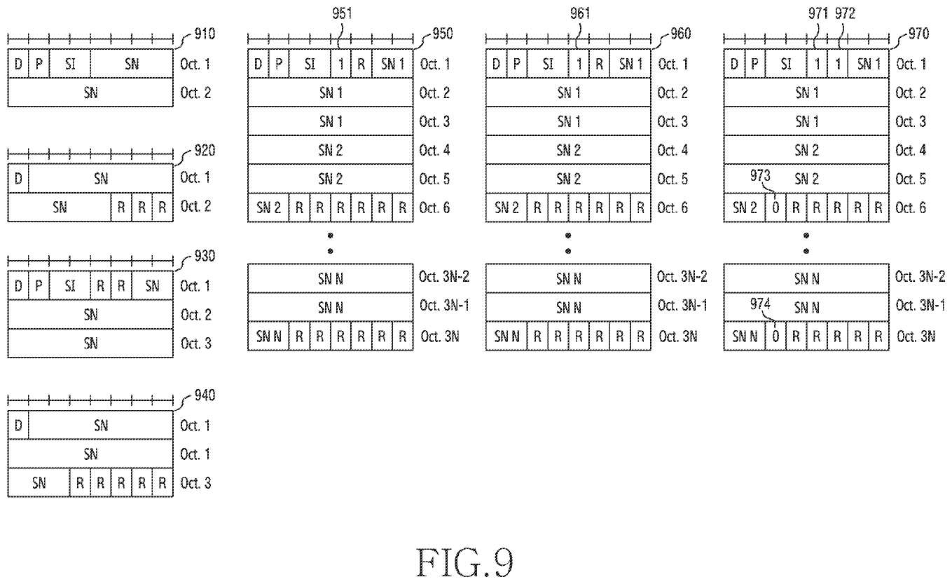

FIG. 9 is a diagram illustrating a method of informing a peer RLC of a discarded RLC SN in the form of an AMD PDU according to various embodiments of the disclosure.

Referring to FIG. 9, when an RLC SDU transmitted to at least one lower layer is discarded, a transmitting side of an AM RLC may inform a peer RLC of the at least one discarded RLC SN in the form of an AMD PDU. A method of discarding the RLC SDU transmitted to the lower layer may be based on the example of FIG. 7.

The AM RLC may be configured to use a 12-bit SN. The transmitting side of the AM RLC may generate an AMD PDU 910 with a 2-byte length including the discarded RLC SN, and may transfer the AMD PDU 910 to the peer RLC so as to inform of the discarded RLC SN. The transmitting side of the AM RLC may indicate the discarded RLC SN irrespective of a P value, or may configure a P value to at least one of 0 or 1 so as to indicate the discarded RLC SN. The transmitting side of the AM RLC may indicate the discarded RLC SN irrespective of an SI value, or may configure an SI value to at least one of 00, 01, 10, or 11 so as to indicate the discarded RLC SN. When the AMD PDU 910 with a 2-byte length is received, the receiving side of the peer AM RLC may determine that it indicates the discarded RLC SN. The receiving side of the peer AM RLC may determine that it indicates the discarded RLC SN irrespective of the P value, or when the P value is 0 and/or 1, may determine that it indicates the discarded RLC SN. The receiving side of the peer AM RLC may determine that it indicates the discarded RLC SN irrespective of the SI value, or when the SI value is at least one of 00, 01, 10, or 11, may determine that it indicates the discarded RLC SN.

The AM RLC may be configured to use a 12-bit SN. The transmitting side of the AM RLC may generate an AMD PDU 920 with a 2-byte length including the discarded RLC SN, and may transfer the AMD PDU 920 to the peer RLC so as to inform of the discarded RLC SN. When the AMD PDU 920 with a 2-byte length is received, the receiving side of the peer AM RLC may determine that it indicates the discarded RLC SN. An R bit may be configured to a value of 0, and when another value is included, the receiving side of the RLC may disregard the corresponding value or may regard the RLC PDU as invalid and may discard the same.

The AM RLC may be configured to use a 18-bit SN. The transmitting side of the AM RLC may generate an AMD PDU 930 with a 3-byte length including the discarded RLC SN, and may transfer the AMD PDU 930 to the peer RLC so as to inform of the discarded RLC SN. The transmitting side of the AM RLC may indicate the discarded RLC SN irrespective of a P value, or may configure a P value to at least one of 0 or 1 so as to indicate the discarded RLC SN. The transmitting side of the AM RLC may indicate the discarded RLC SN irrespective of an SI value, or may configure an SI value to at least one of 00, 01, 10, and 11 so as to indicate the discarded RLC SN. When the AMD PDU 930 with a 3-byte length is received, the receiving side of the peer AM RLC may determine that it indicates the discarded RLC SN. The receiving side of the peer AM RLC may determine that it indicates the discarded RLC SN irrespective of the P value, or when the P value is at least one of 0 or 1, may determine that it indicates the discarded RLC SN. The receiving side of the peer AM RLC may determine that it indicates the discarded RLC SN irrespective of the SI value, or when the SI value is at least one of 00, 01, 10, or 11, may determine that it indicates the discarded RLC SN. An R bit may be configured to a value of 0, and when another value is included, the receiving side of the RLC may disregard the corresponding value or may regard the RLC PDU as invalid and may discard the same.

The AM RLC may be configured to use a 18-bit SN. The transmitting side of the AM RLC may generate an AMD PDU 940 with a 3-byte length including the discarded RLC SN, and may transfer the AMD PDU 940 to the peer RLC so as to inform of the discarded RLC SN. When the AMD PDU 940 with a 3-byte length is received, the receiving side of the peer AM RLC may determine that it indicates the discarded RLC SN. An R bit may be configured to a value of 0, and when another value is included, the receiving side of the RLC may disregard the corresponding value or may regard the RLC PDU as invalid and may discard the same.

The AM RLC may be configured to use a 18-bit SN. The transmitting side of the AM RLC may configure a 5^{th} bit 951 to 1, and may generate an AMD PDU 950 with a 3-byte or more length including the discarded RLC SN, and may transfer the AMD PDU 950 to the peer RLC so as to inform of the discarded RLC SN. The transmitting side of the AM RLC may indicate the discarded RLC SN irrespective of a P value, or may configure a P value to at least one of 0 or 1 so as to indicate the discarded RLC SN. The transmitting side of the AM RLC may indicate the discarded RLC SN irrespective of an SI value, or may configure an SI value to at least one of 00, 01, 10, and 11 so as to indicate the discarded RLC SN. The discarded RLC SN may be included in ascending order. When the AMD PDU 950 with the 5^{th} bit 951 configured to 1 is received, the receiving side of the peer AM RLC may determine that it indicates the discarded RLC SN. The receiving side of the peer AM RLC may determine that it indicates the discarded RLC SN irrespective of the P value, or when the P value is at least one of 0 or 1, may determine that it indicates the discarded RLC SN. The receiving side of the peer AM RLC may determine that it indicates the discarded RLC SN irrespective of the SI value, or when the SI value is at least one of 00, 01, 10, or 11, may determine that it indicates the discarded RLC SN. The receiving side of the peer AM RLC may determine a value obtained by dividing the byte length of the AMD PDU 950 by 3, to be the number of discarded RLC SNs included in the AMD PDU 950. An R bit may be configured to a value of 0, and when another value is included, the receiving side of the RLC may disregard the corresponding value or may regard the RLC PDU as invalid and may discard the same.

The AM RLC may be configured to use a 18-bit SN. The transmitting side of the AM RLC may configure a 5^{th} bit 961 to 1, and may generate an AMD PDU 960 with a 6-byte or more length including the discarded RLC SN, and may transfer the AMD PDU 960 to the peer RLC so as to inform of the discarded RLC SN. The transmitting side of the AM RLC may indicate the discarded RLC SN irrespective of a P value, or may configure a P value to at least one of 0 or 1 so as to indicate the discarded RLC SN. The transmitting side of the AM RLC may indicate the discarded RLC SN irrespective of an SI value, or may configure an SI value to at least one of 00, 01, 10, and 11 so as to indicate the discarded RLC SN. The transmitting side of the AM RLC includes two RLC SNs for every 6 octet units, and may indicate that consecutive RLC SNs from a first RLC SN or higher and a second RLC SN or lower are discarded. The discarded RLC SN may be included in ascending order. When the AMD PDU 960 with the 5^{th} bit 961 configured to 1 is received, the receiving side of the peer AM RLC may determine that it indicates the discarded RLC SN. The receiving side of the peer AM RLC may determine that it indicates the discarded RLC SN irrespective of the P value, or when the P value is at least one of 0 or 1, may determine that it indicates the discarded RLC SN. The receiving side of the peer AM RLC may determine that it indicates the discarded RLC SN irrespective of the SI value, or when the SI value is at least one of 00, 01, 10, or 11, may determine that it indicates the discarded RLC SN. The receiving side of the peer AM RLC may determine a value obtained by dividing the byte length of the AMD PDU 960 by 3, to be the number of discarded RLC SNs included in the AMD PDU 960. With respect to two RLC SNs that may be included for every 6 octet units, the receiving side of the peer AM RLC may determine that consecutive RLC SNs from a first RLC SN or higher and a second RLC SN or lower are discarded. An R bit may be configured to a value of 0, and when another value is included, the receiving side of the RLC may disregard the corresponding value or may regard the RLC PDU as invalid and may discard the same.

The AM RLC may be configured to use a 18-bit SN. The transmitting side of the AM RLC may configure a 5^{th} bit 971 to 1, may generate an AMD PDU 970 with a 3-byte or more length including the discarded RLC SN, and may transfer the AMD PDU 970 to the peer RLC so as to inform of the discarded RLC SN. The transmitting side of the AM RLC may indicate the discarded RLC SN irrespective of a P value, or may configure a P value to at least one of 0 or 1 so as to indicate the discarded RLC SN. The transmitting side of the AM RLC may indicate the discarded RLC SN irrespective of an SI value, or may configure an SI value to at least one of 00, 01, 10, and 11 so as to indicate the discarded RLC SN. The transmitting side of the AM RLC may configure a P to at least one of 0 or 1, may configure an SI to at least one of 00, 01, 10, or 11, may configure a 6^{th} bit 972 of a first octet to 1, or may configure, to 1, 3^{rd} bits 973 and 974 of octets whose octet numbers are multiples of 3 and greater than or equal to 6, and may indicate that consecutive RLC SNs from a first RLC SN or higher and a second RLC SN or lower are discarded, via two RLC SNs that may be included in 3 corresponding octet units and 3 subsequent octet units. The discarded RLC SNs may be included in ascending order, and may be represented by combining a single value or consecutive values. When the AMD PDU 950 with the 5^{th} bit 971 configured to 1 is received, the receiving side of the peer AM RLC may determine that it indicates the discarded RLC SN. The receiving side of the peer AM RLC may determine that it indicates the discarded RLC SN irrespective of the P value, or when the P value is at least one of 0 or 1, may determine that it indicates the discarded RLC SN. The receiving side of the peer AM RLC may determine that it indicates the discarded RLC SN irrespective of the SI value, or when the SI value is at least one of 00, 01, 10, or 11, may determine that it indicates the discarded RLC SN. When the AMD PDU 970 in which the P value is configured to at least one of 0 or 1, the SI value is configured to at least one of 00, 01, 10, or 11, or the 6^{th} bit 972 of the first octet or the 3^{rd} bits 973 and 974 of octets whose octet numbers correspond to multiples of 3 and greater than or equal to 6 are configured to 0, is received, the receiving side of the peer AM RLC may determine that 3 corresponding octet units indicate a single discarded RLC SN. When the P value is configured to at least one of 0 or 1, the SI value is configured to at least one of 00, 01, 10, or 11, or the 6^{th} bit 972 of the first octet or the 3^{rd} bits 973 and 974 of octets whose octet numbers correspond to multiples of 3 and greater than or equal to 6 are configured to 1, the receiving side of the peer AM RLC may determine that consecutive RLC SNs from a first RLC SN or higher and a second RLC SN or lower are discarded, in association with two RLC SNs that may be included in the 3 corresponding octet units and 3 subsequent octet units. An R bit may be configured to a value of 0, and when another value is included, the receiving side of the RLC may disregard the corresponding value or may regard the RLC PDU as invalid and may discard the same.

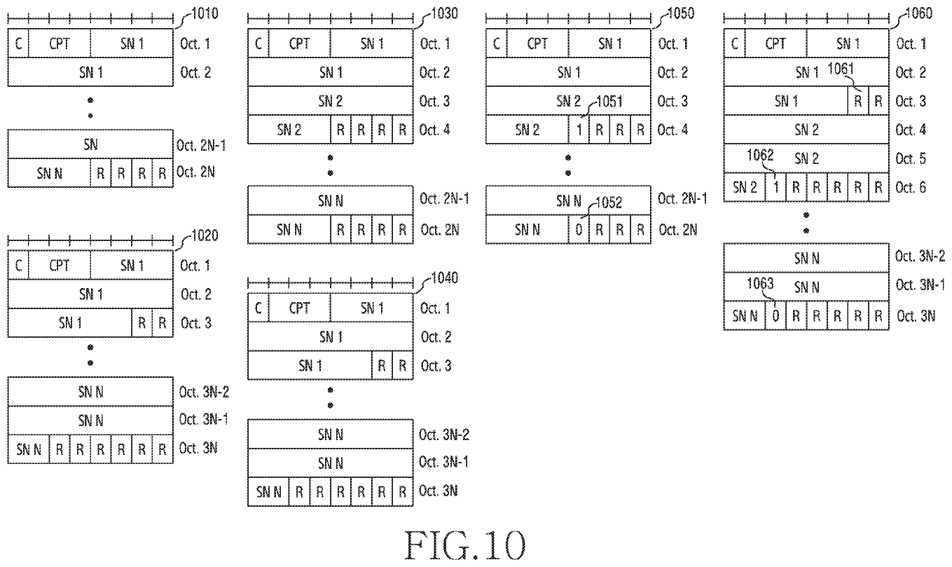

FIG. 10 is a diagram illustrating a method of informing a peer RLC of a discarded RLC SN in the form of a CONTRL PDU according to various embodiments of the disclosure.

Referring to FIG. 10, when an RLC SDU transmitted to at least one lower layer is discarded, a transmitting side of an AM RLC may inform a peer RLC of the at least one discarded RLC SN in the form of a CONTROL PDU. A method of discarding the RLC SDU transmitted to the lower layer may be based on the example of FIG. 7.

The AM RLC may be configured to use a 12-bit SN. The transmitting side of the AM RLC may configure a control PDU type (CPT) to a predetermined value, for example, 001, and may generate a CONTROL PDU 1010 with a 2-byte or more length including the discarded RLC SN, and may transfer the CONTROL PDU 1010 to the peer RLC so as to inform of the discarded RLC SN. The discarded RLC SN may be included in ascending order. When the CONTOL PDU 1010 with the CPT configured to the predetermined value, for example, 001 is received, the receiving side of the peer AM RLC may determine that it indicates the discarded RLC SN. The receiving side of the peer AM RLC may determine a value obtained by dividing the byte length of the CONTROL PDU 1010 by 2, to be the number of discarded RLC SNs included in the CONTROL PDU 1010. An R bit may be configured to a value of 0, and when another value is included, the receiving side of the RLC may disregard the corresponding value or may regard the RLC PDU as invalid and may discard the same.

The AM RLC may be configured to use a 18-bit SN. The transmitting side of the AM RLC may configure a CPT to a predetermined value, for example, 001, may generate a CONTROL PDU 1020 with a 3-byte or more length including the discarded RLC SN, and may transfer the CONTROL PDU 1020 to the peer RLC so as to inform of the discarded RLC SN. The discarded RLC SN may be included in ascending order. When the CONTOL PDU 1020 with the CPT configured to the predetermined value, for example, 001 is received, the receiving side of the peer AM RLC may determine that it indicates the discarded RLC SN. The receiving side of the peer AM RLC may determine a value obtained by dividing the byte length of the CONTROL PDU 1020 by 3, to be the number of discarded RLC SNs included in the CONTROL PDU 1020. An R bit may be configured to a value of 0, and when another value is included, the receiving side of the RLC may disregard the corresponding value or may regard the RLC PDU as invalid and may discard the same.

The AM RLC may be configured to use a 12-bit SN. The transmitting side of the AM RLC may configure a CPT to a predetermined value, for example, 001 or 010, may generate a CONTROL PDU 1030 with a 4-byte or more length including the discarded RLC SN, and may transfer the CONTROL PDU 1030 to the peer RLC so as to inform of the discarded RLC SN. The transmitting side of the AM RLC includes two RLC SNs for every 4 octet units, and may indicate that consecutive RLC SNs from a first RLC SN or higher and a second RLC SN or lower are discarded. The discarded RLC SN may be included in ascending order. When the CONTOL PDU 1030 with the CPT configured to the predetermined value, for example, 001 or 010 is received, the receiving side of the peer AM RLC may determine that it indicates the discarded RLC SN. The receiving side of the peer AM RLC may determine a value obtained by dividing the byte length of the CONTROL PDU 1030 by 2, to be the number of discarded RLC SNs included in the CONTROL PDU 1030. With respect to two RLC SNs that may be included for every 4 octet units, the receiving side of the peer AM RLC may determine that consecutive RLC SNs from a first RLC SN or higher and a second RLC SN or lower are discarded. An R bit may be configured to a value of 0, and when another value is included, the receiving side of the RLC may disregard the corresponding value or may regard the RLC PDU as invalid and may discard the same.

The AM RLC may be configured to use a 18-bit SN. The transmitting side of the AM RLC may configure a CPT to a predetermined value, for example, 001 or 010, may generate a CONTROL PDU 1040 with a 6-byte or more length including the discarded RLC SN, and may transfer the CONTROL PDU 1040 to the peer RLC so as to inform of the discarded RLC SN. The transmitting side of the AM RLC includes two RLC SNs for every 6 octet units, and may indicate that consecutive RLC SNs from a first RLC SN or higher and a second RLC SN or lower are discarded. When the CONTOL PDU 1040 with the CPT configured to the predetermined value, for example, 001 or 010 is received, the receiving side of the peer AM RLC may determine that it indicates the discarded RLC SN. The receiving side of the peer AM RLC may determine a value obtained by dividing the byte length of the CONTROL PDU 1040 by 3, to be the number of discarded RLC SNs included in the CONTROL PDU 1040. With respect to two RLC SNs that may be included for every 6 octet units, the receiving side of the peer AM RLC may determine that consecutive RLC SNs from a first RLC SN or higher and a second RLC SN or lower are discarded. An R bit may be configured to a value of 0, and when another value is included, the receiving side of the RLC may disregard the corresponding value or may regard the RLC PDU as invalid and may discard the same.

The AM RLC may be configured to use a 12-bit SN. The transmitting side of the AM RLC may configure a CPT to a predetermined value, for example, 001, 010, or 011, may generate a CONTROL PDU 1050 with a 2-byte or more length including the discarded RLC SN, and may transfer the CONTROL PDU 1050 to the peer RLC so as to inform of the discarded RLC SN. The transmitting side of the AM RLC may configure the CPT to a predetermined value, for example, 001 or 010, or may configure, to 0, 5^{th} bits 1051 and 1052 of even numbered octets whose octet numbers are greater than or equal to 4, so as to indicate that a single RLC SN that may be included in 2 corresponding octet units is discarded. The transmitting side of the AM RLC may configure the CPT to a predetermined value, for example, 010 or 011, or may configure, to 1, 5^{th} bits 1051 and 1052 of even numbered octets whose octet numbers are greater than or equal to 4, and may indicate consecutive RLC SNs from a first RLC SN or higher and a second RLC SN or lower are discarded via two RLC SNs that may be included in 2 corresponding octet units and subsequent 2 octet units. The discarded RLC SNs may be included in ascending order, and may be represented by combining a single value or consecutive values. When the CONTOL PDU 1050 with the CPT configured to a predetermined value, for example, at least one of 001, 010, 011 is received, the receiving side of the peer AM RLC may determine that it indicates the discarded RLC SN. The receiving side of the peer AM RLC may determine a value obtained by dividing the byte length of the CONTROL PDU 1050 by 2, to be the number of discarded RLC SNs included in the CONTROL PDU 1050. When the CPT is configured to a predetermined value, for example, 001 or 010, or when the 5^{th} bits 1051 and 1052 of even numbered octets whose octet numbers are greater than or equal to 4 are configured to 0, the receiving side of the peer AM RLC may determine that the discarded RLC SN corresponding to the 2 corresponding octet units is a single value. When the CPT is configured to a predetermined value, for example, 010 or 011, or 5^{th} bits 1051 and 1052 of octets, whose octet numbers are multiples of 2 and greater than or equal to 4, are configured to 1, the receiving side of the peer AM RLC may determine that consecutive RLC SNs from a first RLC SN or higher and a second RLC SN or lower are discarded in association with two RLC SNs that may be included in 4 octet units corresponding to 2 corresponding octet units and 2 subsequent octet units. An R bit may be configured to a value of 0, and when another value is included, the receiving side of the RLC may disregard the corresponding value or may regard the RLC PDU as invalid and may discard the same.

The AM RLC may be configured to use a 18-bit SN. The transmitting side of the AM RLC may configure a CPT to a predetermined value, for example, at least one of 001, 010, or 011, may generate a CONTROL PDU 1060 with a 3-byte or more length including the discarded RLC SN, and may transfer the CONTROL PDU 1060 to the peer RLC so as to inform of the discarded RLC SN. The transmitting side of the AM RLC may configure the CPT to a predetermined value, for example, 001 or 010, or may configure a 7^{th} bit 1061 of a third octet to 0, or may configure, to 0, 3^{rd} bits 1062 and 1063 of octets whose octet numbers are multiples of 3 and greater than or equal to 6, so as to indicate that a single RLC SN that may be included in the 3 corresponding octet units is discarded. The transmitting side of the AM RLC may configure the CPT to a predetermined value, for example, 010 or 011, may configure a 7^{th} bit 1061 of the third octet to 1, or may configure, to 1, 3^{rd} bits 1062 and 1063 of octets whose octet numbers are multiples of 3 and greater than or equal to 6, and may indicate consecutive RLC SNs from a first RLC SN or higher and a second RLC SN or lower are discarded via two RLC SNs that may be included in 3 corresponding octet units and 3 subsequent octet units. The discarded RLC SNs may be included in ascending order, and may be represented by combining a single value or consecutive values. When the CONTOL PDU 1060 with the CPT configured to the predetermined value, for example, at least one of 001, 010, or 011 is received, the receiving side of the peer AM RLC may determine that it indicates the discarded RLC SN. The receiving side of the peer AM RLC may determine a value obtained by dividing the byte length of the CONTROL PDU 1060 by 3, to be the number of discarded RLC SNs included in the CONTROL PDU 1060. When the CPT is configure to a predetermined value, for example, 001 or 010, or the 7^{th} bit 1061 of the third octet is configured to 0, or the 3^{rd} bits 1062 and 1063 of octets whose octet numbers are multiples of 3 and greater than or equal to 6 are configured to 0, the receiving side of the peer AM RLC may determine that the discarded RLC SN corresponding to the 3 corresponding octet units is a single value. When the CPT is configured to a predetermined value, for example, 010 or 011, the 7^{th} bit 1061 of the third octet is configured to 1, or the 3^{rd} bits 1062 and 1063 of octets whose octet numbers are multiples of 3 and greater than or equal to 6 are configured to 1, the receiving side of the peer AM RLC may determine that consecutive RLC SNs from a first RLC SN or higher and a second RLC SN or lower are discarded in association with two RLC SNs that may be included in 6 octet units corresponding to 3 corresponding octet units and 3 subsequent octet units. An R bit may be configured to a value of 0, and when another value is included, the receiving side of the RLC may disregard the corresponding value or may regard the RLC PDU as invalid and may discard the same.

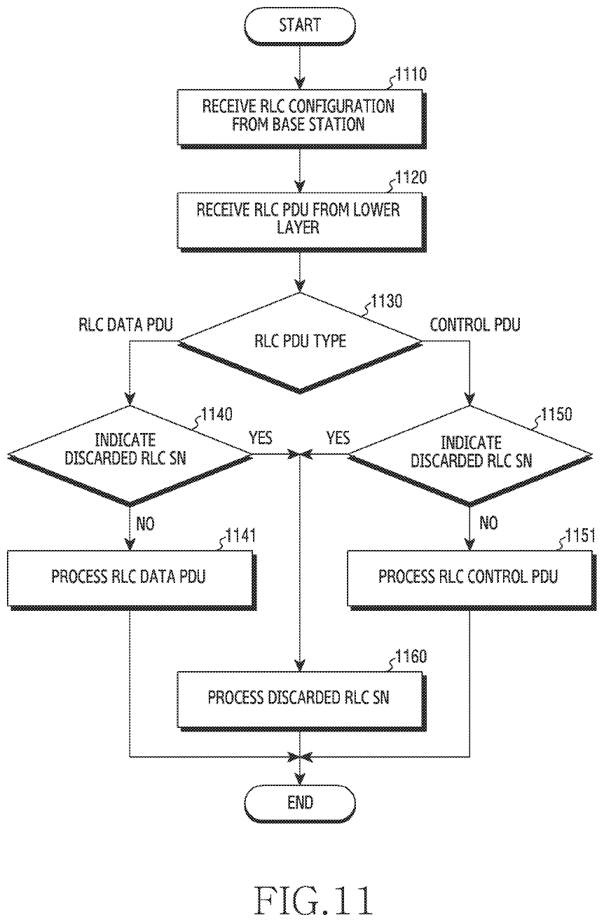

FIG. 11 is a flowchart illustrating operation of an RLC receiving side according to various embodiments of the disclosure.

Referring to FIG. 11, in operation 1110, a base station may transfer configuration information of an RLC entity for transmitting a DRB to a receiving side of the RLC via RRC signaling, and the configuration that may be transferred may be as shown in the example in Table 6. Transmission of the RRC signaling may be based on the example of FIG. 6.

In operation 1120, the receiving side of the RLC may receive an RLC PDU, for example, at least one of an RLC Data PDU or RLC CONTROL PDU, from a lower layer.

In operation 1130, the receiving side of the RLC may distinguish a type of the RLC PDU received in operation 1120, for example, an RLC Data PDU or an RLC CONTROL PDU. The receiving side of the RLC may include a UMD PDU type in the case of an UM RLC, and may include at least one of an AMD PDU type or a CONTROL PDU type in the case of an AM RLC, and may use a first bit (e.g., data/control (D/C) bit) to identify whether it is an AMD PDU or a CONTROL PDU.

When it is the RLC Data PDU, the receiving side of the RLC may proceed with operation 1140. When it is the CONTROL PDU, the receiving side of the RLC may proceed with operation 1150. A method in which the peer RLC transmits the RLC PDU may be based on the example of FIG. 7.

In operation 1140, the receiving side of the RLC may identify whether the RLC Data PDU indicates a discarded RLC SN. A method of identifying the same may be based on the example of at least one of FIG. 8 or FIG. 9. When the RLC Data PDU does not indicate a discarded RLC SN, the receiving side of the RLC may proceed with operation 1141. When the RLC Data PDU indicates a discarded RLC SN, the receiving side of the RLC may proceed with operation 1160.

In operation 1141, the receiving side of the RLC may process the RLC Data PDU received in operation 1120. The receiving side of the RLC may perform at least one of an operation of configuring and/or updating state variables, an operation of starting (restarting or stopping) a timer, an operation of discarding the received RLC Data PDU, an operation of storing the received RLC Data PDU in a reception buffer, or an operation of discarding a redundant byte segment of an RLC SDU. In addition, when all byte segments associated with an RLC SN are received, the receiving side of the RLC may transfer a reassembled RLC SDU to an upper layer, and may perform at least one of an operation of configuring or updating state variables or an operation of starting (restarting or stopping) a timer. The details of operation 1141 may be as shown in the example of Table 9.

```
TABLE 9
  5.2.2.2 Receive operations
  5.2.2.2.1 General
  The receiving UM RLC entity shall maintain a reassembly window according to state variable
RX_Next_Highest as follows:
  - a SN falls within the reassembly window if (RX_Next_Highest − UM_Window_Size) <= SN <
RX_Next_Highest;
  - a SN falls outside of the reassembly window otherwise.
  When receiving an UMD PDU from lower layer, the receiving UM RLC entity shall:
  - either deliver the UMD PDU to upper layer after removing the RLD header, discard the
received UMD PDU, or place it in the reception buffer (see clause 5.2.2.2.2);
  - if the received UMD PDU was placed in the reception buffer:
  - update state variables, reassemble and deliver RLC SDUs to upper layer and start/stop t-
Reassembly as needed (see clause 5.2.2.2.3).
  When t-Reassembly expires, the receiving UM RLC entity shall:
  - update state variables, discard RLC SDU segments and start t-Reassembly as needed (see
clause 5.2.2.2.4).
  5.2.2.2.2 Actions when an UMD PDU is received from lower layer
  When an UMD PDU is received from lower layer, the receiving UM RLC shall:
  - if the UMD PDU header does not contain an SN:
  - remove the RLC header and deliver the RLC SDU to upper layer.
  - else if (RX_Next_Highest − UM_Window_Size) <= SN < RX_Next_Reassembly:
  - discard the received UMD PDU.
  - else:
  - place the received UMD PDU in the reception buffer.
  5.2.2.2.3 Actions when an UMD PDU is placed in the reception buffer
  When an UMD PDU with SN = x is placed in the reception buffer, the receiving UM RLC entity shall:
  - if all byte segments with SN = x are received:
  - reassemble the RLC SDU from all byte segments with SN = x, remove RLC headers and deliver
the reassembled RLC SDU to upper layer;
  - if x = RX_Next_Reassembly:
  - update RX_Next_Reassembly to the SN of the first SN > current RX_Next_Reassembly that
has not been reassembled and delivered to upper layer.
  - else if x falls outside of the reassembly window:
  - update RX_Next_Highest to x + 1;
  - discard any UMD PDUs with SN that falls outside of the reassembly window;
  - if RX_Next_Reassembly falls outside of the reassembly window:
  - set RX_Next_Reassembly to the SN of the first SN >= (RX_Next_Highest −
UM_Window_Size) that has not been reassembled and delivered to upper layer.
  - if t-Reassembly is running:
  - if RX_Timer_Trigger <= RX_Next_Reassembly; or
  - if RX_Timer_Trigger falls outside of the reassembly window and RX_Timer_Trigger is not
equal to RX_Next_Highest; or
  - if RX_Next_Highest = RX_Next_Reassembly + 1 and there is no missing byte segment of the
RLC SDU associated with SN = RX_Next_Reassembly before the last byte of all received segments of this RLC
SDU:
  - stop and reset t-Reassembly.
  - if t-Reassembly is not running (includes the case when t-Reassembly is stopped due to actions
above):
  - if RX_Next_Highest > RX_Next_Reassembly + 1; or
  - if RX_Next_Highest = RX_Next_Reassembly + 1 and there is at least one missing byte
segment of the RLC SDU associated with SN = RX_Next_Reassembly before the last byte of all received segments
of this RLC SDU:
  - start t-Reassembly;
  - set RX_Timer_Trigger to RX_Next_Highest.
  5.2.2.2.4 Actions when t-Reassembly expires
  When t-Reassembly expires, the receiving UM RLC entity shall:
  - update RX_Next_Reassembly to the SN of the first SN >= RX_Timer_Trigger that has not
been reassembled;
  - discard all segments with SN < updated RX_Next_Reassembly;
  - if RX_Next_Highest > RX_Next_Reassembly + 1; or
  - if RX_Next_Highest = RX_Next_Reassembly + 1 and there is at least one missing byte
segment of the RLC SDU associated with SN = RX_Next_Reassembly before the last byte of all received
segments of this RLC SDU:
  - start t-Reassembly;
  - set RX_Timer_Trigger to RX_Next_Highest.
  5.2.3.2 Receive operations
  5.2.3.2.1 General
  The receiving side of tan AM RLC entity shall maintain a receiving window according to state variable
RX_Next as follows:
  - a SN falls within the receiving window if RX_Next <= SN < RX_Next + AM_Window_Size;
  - a SN falls outside of the receiving window otherwise.
  When receiving an AMD PDU from lower layer, the receiving side of an AM RLC entity shall:
  - either discard the received AMD PDU or place it in the reception buffer (see clause 5.2.2.2.2);
  - if the received AMD PDU was placed in the reception buffer:
  - update state variables, reassemble and deliver RLC SDUs to upper layer and start/stop t-
Reassembly as needed (see clause 5.2.2.2.3).
  When t-Reassembly expires, the receiving AM RLC entity shall:
  - update state variables and start t-Reassembly as needed (see clause 5.2.2.2.4).
  5.2.2.2.2 Actions when an AMD PDU is received from lower layer
  When an AMD PDU is received from lower layer, where the AMD PDU contains byte segment numbers
y to z of an RLC SDU with SN = x, the receiving side of an AM RLC entity shall:
  - if x falls outside of the receiving window; or
  - if byte segment numbers y to z of the RLC SDU with SN = x have been received before:
  - discard the received AMD PDU.
  - else:
  - place the received AMD PDU in the reception buffer;
  - if some byte segments of the RLC SDU contained in the AMD PDU have been received before:
  - discard the duplicate byte segments.
  5.2.3.2.3 Actions when an AMD PDU is placed in the reception buffer
  When an AMD PDU with SN = x is placed in the reception buffer, the receiving side of an AM RLC
entity shall:
  - if x >= RX_Next_Highest:
  - update RX_Next_Highest to x + 1;
  - if all bytes of the RLC SDU with SN = x are received:
  - reassemble the RLC SDU from AMD PDU(s) with SN = x, remove RLC headers when doing
so and deliver the reassembled RLC SDU to upper layer;
  - if x = RX_Highest_Status:
  - update RX_Highest_Status to the SN of the first RLC SDU with SN > current
RX_Highest_Status for which not all bytes have been received.
  - if x = RX_Next:
  - update RX_Next to the SN of the first RLC SDU with SN > current RX_Next for which not all
bytes have been received.
  - if t-Reassembly is running:
  - if RX_Next_Status_Trigger = RX_Next; or
  - if RX_Next_Status_Trigger = RX_Next + 1 and there is no missing byte segment of the SDU
associated with SN = RX_Next before the last byte of all received segments of this SDU; or
  - if RX_Next_Status_Trigger falls outside of the receiving window and
RX_Next_Status_Trigger is not equal to RX_Next + AM_Window_Size:
  - stop and reset t-Reassembly.
  - if t-Reassembly is not running (includes the case t-Reassembly is stopped due to actions above):
  - if RX_Next_Highest > RX_Next + 1; or
  - if RX_Next_Highest > RX_Next + 1 and there is at least one missing byte segment of the SDU
associated with SN = RX_Next before the last byte of all received segments of this SDU:
  - start t-Reassembly;
  - set RX_Next_Status_Trigger to RX_Next_Highest.
  5.2.3.2.4 Actions when
  When t-Reassembly expires, the receiving side of an AM RLC entity shall:
  - update RX_Highest_Status to the SN of the first RLC SDU with SN >=
RX_Next_Status_Trigger for which not all bytes have been received.
  - if RX_Next_Highest > RX_Highest + 1; or
  - if RX_Next_Highest = RX_Highest_Status + 1 and there is at least one missing byte segment
of the SDU associated with SN = RX_Highest_Status before the last byte of all received segments of this SDU:
  - start t-Reassembly;
  - set RX_Next_Status_Trigger to RX_Next_Highest.
```

In operation 1150, the receiving side of the RLC may identify whether the RLC CONTROL PDU indicates a discarded RLC SN. A method of identifying the same may be based on the example of FIG. 10. When the RLC CONTROL PDU does not indicate a discarded RLC SN, the receiving side of the RLC may proceed with operation 1151. When the RLC CONTROL PDU indicates a discarded RLC SN, the receiving side of the RLC may proceed with operation 1160.

In operation 1151, the receiving side of the RLC may process the RLC CONTROL PDU received in operation 1120. The RLC CONTROL PDU may include a STATUS PDU. When the STATUS PDU is received, and an RLC SN included in the STATUS PDU indicates a positive acknowledgement, the transmission side of the AM RLC may inform an upper layer of successful transmission of an RLC SDU corresponding to the RLC SN, and may configure state variables. The details of the operation of processing the STATUS PDU may be as shown in the example of Table 10.

```
TABLE 10
      The transmitting side of an AM RLC entity can receive a positive acknowledgement (confirmation of
successful reception by its peer AM RLC entity) for an RLC SDU by the following:
      - STATUS PDU from its peer AM RLC entity.
      When receiving a positive acknowledgement for an RLC SDU with SN = x, the transmitting side of an
AM RLC entity shall:
      - send an indication to the upper layers of successful delivery of the RLC SDU;
      - set TX_Next_Ack equal to the SN of the RLC SDU with the smallest SN, whose SN falls
within the range TX_Next_Ack <= SN <= TX_Next and for which a positive acknowledgment has not been
received yet.
```

In operation 1160, when the RLC PDU received in operation 1120 indicates a discarded RLC SN, the receiving side of the RLC may process the discarded RLC SN. The receiving side of the RLC may process the discarded RLC SN in the same manner as when at least one of a UM or AM data PDU corresponding to the discarded RLC SN is received. The receiving side of the RLC may perform at least one of an operation of configuring (or updating) a state variable associated with the discarded RLC SN or an operation of starting (restarting or stopping) a timer. The receiving side of the RLC may process all the byte segments of the discarded RLC SN as received. When byte segments of the discarded RLC SN exist in a reception buffer, the byte segments of the discarded RLC SN may not be transferred to an upper layer and may be discarded. The UM RLC's detailed operation of processing a discarded RLC SN may be as shown in the example of Table 11.

```
TABLE 11
      When receiving a discarded RLC SN indication with SN = x from lower layer, the receiving UM RLC
entity shall:
      - if (RX_Next_Highest − UM_Window_Size) <= SN < RX_Next_Reassembly:
      - discard the received UMD PDU.
      - consider all byte segments with SN = x are received.
      - if x = RX_Next_Reassembly:
      - update RX_Next_Reassembly to the SN of the first SN > current RX_Next_Reassembly that
has not been reassembled and delivered to upper layer.
      - else if x falls outside of the reassembly window;
      - update RX_Next_Highest to x + 1;
      - discard any UMD PDUs with SN that falls outside of the reassembly window;
      - if RX_Next_Reassembly falls outside of the reassembly window;
      - set RX_Next_Reassembly to the SN of the first SN >= (RX_Next_Highest −
UM_Window_Size) that has not been reassembled and delivered to upper layer.
      - if t-Reassembly is running [symbol]
      - if RX_Timer_Trigger <= RX_Next_Reassembly; or
      - if RX_Timer_Trigger falls outside of the reassembly window and RX_Timer_Trigger is not
equal to RX_Next_Highest; or
      - if RX_Next_Highest = RX_Next_Reassembly + 1 and there is no missing byte segment of the
RLC SDU associated with SN [symbol]     RX_Next_Reassembly before the last byte of all received segments of this RLC
SDU;
      - stop and reset t-Reassembly.
      - if t-Reassembly is not running (includes the case when t-Reassembly is stopped due to actions
above);
      - if RX_Next_Highest > RX_Next_Reassembly + 1; or
      - if RX_Next_Highest = RX_Next_Reassembly + 1 and there is at least one missing byte
segment of the RLC SDU associated with SN = RX_Next_Reassembly before the last byte of all received segments
of this RLC SDU;
      - start t-Reassembly;
      - set RX_Timer_Trigger to RX_Next_Highest. [symbol]
indicates data missing or illegible when filed
```

The AM RLC's detailed operation of processing a discarded RLC SN may be as shown in the example of Table 12.

```
TABLE 12
      When receiving an discarded RLC SN indication with SN = x from lower layer, the receiving AM RLC
entity shall:
      - if x falls outside of the receiving window:
      - discard the received AMD PDU.
      - if x >= RX_Next_Highest:
      - update RX_Next_Highest to x + 1.
      - consider all byte segments with SN = x are received.
      - if x = RX_Highest_Status:
      - update RX_Highest_Status to the SN of the first RLC SDU with SN > current
RX_Highest_Status for which not all bytes have been received.
      - if x = RX_Next to the SN of the first RLC SDU with SN > current RX_Next for which not all
bytes have been received.
      - if t-Reassembly is running:
      - if RX_Next_Status_Trigger = RX_Next; or
      - if RX_Next_Status_Trigger = RX_Next + 1 and there is no missing byte segment of the SDU
associated with SN = RX_Next before the last byte of all received segments of this SDU; or
      - if RX_Next_Status_Trigger falls outside of the receiving window and
RX_Next_Status_Trigger is not equal to RX_Next + AM_Window_Size:
      - stop and reset t-Reassembly.
      - if t-Reassembly is not running (includes the case t-Reassembly is stopped due to actions above):
      - if RX_Next_Highest> RX_Next + 1; or
      - if RX_Next_Highest = RX_Next + 1 and there is at least one missing byte segment of the SDU
associated with SN = RX_Next before the last byte of all received segments of this SDU:
      - start t-Reassembly;
      - set RX_Next_Status_Trigger to RX_Next_Highest.
```

In the above-described embodiments of the disclosure, a method of representing or determining (identifying) a discarded RLC SN is not limited to any one of the above-described methods but may include a combination of some or all of the above-described methods.

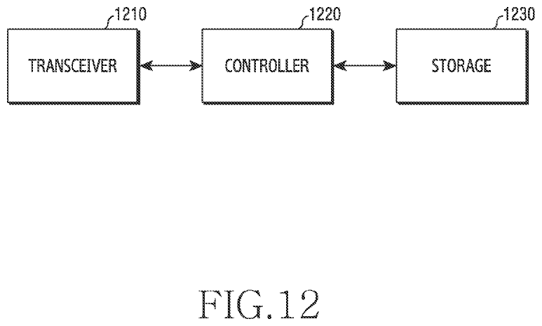

FIG. 12 is a block diagram illustrating an internal structure of a base station according to various embodiments of the disclosure.

Referring to FIG. 12, the base station may include a transceiver 1210, a controller 1220, and a storage 1230. The transceiver 1210, the controller 1220, and/or the storage 1230 may be operated according to the above-described communication methods of the base station. A network device may also correspond to the structure of the base station. However, components of the base station are not limited to the above-described example. For example, the base station may include a larger or smaller number of components than the above-described components. For example, the base station may include the transceiver 1210 and the controller 1220. Furthermore, the transceiver 1210, the controller 1220, and/or the storage 1230 may be implemented in the form of a single chip.

The transceiver 1210 refers to a base station receiver and a base station transmitter as a whole, and may transmit/receive signals with UEs, other base stations, and other network devices. The transmitted/received signals may include control information and data. The transceiver 1210 may transmit, for example, system information, synchronization signals, or reference signals to UEs. To this end, the transceiver 1210 may include an RF transmitter configured to up-convert and amplify the frequency of transmitted signals, an RF receiver configured to low-noise-amplify received signals and down-convert the frequency thereof, and the like. However, this is only an embodiment of the transceiver 1210, and the components of the transceiver 1210 are not limited to the RF transmitter and the RF receiver. The transceiver 1210 may include wired/wireless transceivers, and may include various components for transmitting/receiving signals. In addition, the transceiver 1210 may receive signals through a communication channel (e.g., a radio channel), output the same to the controller 1220, and transmit signals output from the controller 1220 through the communication channel. Furthermore, the transceiver 1210 may receive communication signals, output same to a processor, and transmit signals output from the processor to UEs, other base stations, or other network entities through a wired/wireless network.

The storage 1230 may store programs and data necessary for operations of the base station. In addition, the storage 1230 may store control information or data included in signals acquired by the base station. The storage 1230 may include storage media such as a ROM, a RAM, a hard disk, a CD-ROM, and a DVD, or a combination of storage media. In addition, the storage 1230 may store at least one of information transmitted/received through the transceiver 1210 and information generated through the controller 1220.

As used herein, the controller 1220 may be defined as a circuit, an application specific integrated circuit, or at least one processor. The processor may include a communication processor (CP) which performs control for communication and an application processor (AP) which controls upper layers such as application programs. The controller 1220 may control the overall operation of the base station according to the embodiments proposed in the disclosure. For example, the controller 1220 may control signal flows between the respective blocks to perform operations according to the above-described flowcharts.

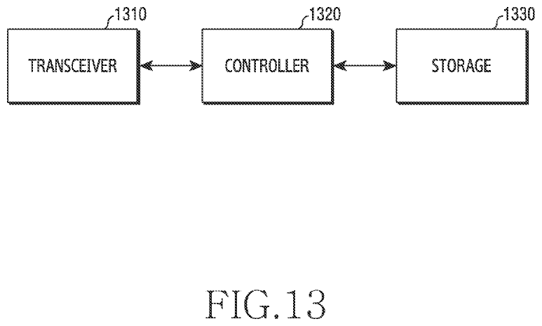

FIG. 13 is a block diagram illustrating a structure of a UE according to an embodiment of the disclosure.

Referring to FIG. 13, the UE may include a transceiver 1310, a controller 1320, and a storage 1330. The transceiver 1310, the controller 1320, and the storage 1330 may be operated according to the above-described communication methods of the UE. Components of the UE are not limited to the above-described example. For example, the UE may include a larger or smaller number of components than the above-described components. For example, the UE may include the transceiver 1310 and the controller 1320. Furthermore, the transceiver 1310, the controller 1320, and the storage 1330 may be implemented in the form of a single chip.

The transceiver 1310 refers to a UE receiver and a UE transmitter as a whole, and may transmit/receive signals with base stations, other UEs, and other network entities. The signals transmitted/received with the base stations may include control information and data. The transceiver 1310 may receive, for example, system information, synchronization signals, or reference signals from the base station. To this end, the transceiver 1310 may include an RF transmitter configured to up-convert and amplify the frequency of transmitted signals, an RF receiver configured to low-noise-amplify received signals and down-convert the frequency thereof, and the like. However, this is only an embodiment of the transceiver 1310, and the components of the transceiver 1310 are not limited to the RF transmitter and the RF receiver. Also, the transceiver 1310 may include wired/wireless transceivers, and may include various components for transmitting/receiving signals. In addition, the transceiver 1310 may receive signals through a radio channel, output the same to the controller 1320, and transmit signals output from the controller 1320 through the radio channel. Furthermore, the transceiver 1310 may receive communication signals, output same to a processor, and transmit signals output from the processor to network entities through a wired/wireless network.

The storage 1330 may store programs and data necessary for operations of the UE. In addition, the storage 1330 may store control information or data included in signals acquired by the UE. The storage 1330 may include storage media such as a ROM, a RAM, a hard disk, a CD-ROM, and a DVD, or a combination of storage media.

As used herein, the controller 1320 may be defined as a circuit, an application specific integrated circuit, or at least one processor. The processor may include a communication processor (CP) which performs control for communication and an application processor (AP) which controls upper layers such as application programs. The controller 1320 may control the overall operation of the UE according to the embodiments proposed in the disclosure. For example, the controller 1320 may control signal flows between the respective blocks to perform operations according to the above-described flowcharts.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Furthermore, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Also, the above respective embodiments may be employed in combination, as necessary. For example, a part of one embodiment of the disclosure may be combined with a part of another embodiment to operate a base station and a terminal. As an example, a part of a first embodiment of the disclosure may be combined with a part of a second embodiment to operate a base station and a terminal. Moreover, although the above embodiments have been described based on the FDD LTE system, other variants based on the technical idea of the embodiments may also be implemented in other communication systems such as TDD LTE, and 5G, or NR systems.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

In addition, in methods of the disclosure, some or all of the contents of each embodiment may be implemented in combination without departing from the essential spirit and scope of the disclosure.

Various embodiments of the disclosure have been described above. The above description of the disclosure is for the purpose of illustration, and is not intended to limit embodiments of the disclosure to the embodiments set forth herein. Those skilled in the art will appreciate that other specific modifications and changes may be easily made to the forms of the disclosure without changing the technical idea or essential features of the disclosure. The scope of the disclosure is defined by the appended claims, rather than the above detailed description, and the scope of the disclosure should be construed to include all changes or modifications derived from the meaning and scope of the claims and equivalents thereof.

1. A method performed by a radio link control (RLC) transmitting side in a wireless communication system, the method comprising:
receiving configuration information associated with an RLC from a base station;
receiving, from a packet data convergence protocol (PDCP) layer, a message for requesting discarding of at least one RLC service data unit (SDU); and
discarding the at least one RLC SDU, based on the configuration information,
wherein the at least one RLC SDU comprises at least one RLC SDU segment.

2. The method of claim 1, further comprising identifying whether the at least one RLC SDU has been transmitted to a lower layer.

3. The method of claim 1, further comprising transmitting an RLC protocol data unit (PDU) including a sequence number (SN) of the RLC SDU to a lower layer,
wherein the configuration information further comprises configuration information associated with the SN.

4. The method of claim 3, wherein the SN is included in at least one of an RLC unacknowledged mode data (UMD) PDU, an RLC acknowledged mode data (AMD) PDU, or an RLC control PDU.

5. A method performed by a radio link control (RLC) receiving side in a wireless communication system, the method comprising:
receiving an RLC protocol data unit (PDU) from a lower layer;
identifying whether the RLC PDU includes a sequence number (SN) of at least one discarded RLC service data unit (SDU);
performing discarding of the RLC SDU corresponding to the SN in the RLC PDU; and
processing reception of the RLC SDU corresponding to the SN as completed,
wherein the at least one RLC SDU comprises at least one RLC SDU segment.

6. The method of claim 5, further comprising identifying a type of the RLC PDU,
wherein, in case that the RLC PDU includes the SN, discarding of the RLC SDU corresponding to the SN is performed, and
wherein the RLC PDU is an RLC data PDU or RLC control PDU.

7. The method of claim 5, wherein the SN is included in at least one of an RLC unacknowledged mode data (UMD) PDU, an RLC acknowledged mode data (AMD) PDU, or an RLC control PDU.

8. A radio link control (RLC) transmitting side in a wireless communication system, the RLC transmitting side comprising:
a transceiver; and
at least one controller coupled with the transceiver,
wherein the at least one controller is configured to:
receive configuration information associated with an RLC layer from a base station;
receive, from a packet data convergence protocol (PDCP) layer, a message for requesting discarding of at least one RLC service data unit (SDU), and
discard the at least one RLC SDU based on the configuration information,
wherein the at least one RLC SDU comprises at least one RLC SDU segment.

9. The RLC transmitting side of claim 8, wherein the at least one controller is further configured to identify whether the at least one RLC SDU has been transmitted to a lower layer.

10. The RLC transmitting side of claim 8, wherein the at least one controller is further configured to transmit an RLC protocol data unit (PDU) including a sequence number (SN) of the RLC SDU to a lower layer, and
wherein the configuration information further comprises configuration information associated with the SN.

11. The RLC transmitting side of claim 10, wherein the SN is included in at least one of an RLC unacknowledged mode data (UMD) PDU, an RLC acknowledged mode data (AMD) PDU, or an RLC CONTROL PDU.

12. A radio link control (RLC) receiving side in a wireless communication system, the RLC receiving side comprising:
a transceiver; and
at least one controller coupled with the transceiver,
wherein the at least one controller is configured to:
receive an RLC protocol data unit (PDU) from a lower layer;
identify whether the RLC PDU includes a sequence number (SN) of at least one discarded RLC service data unit (SDU);
perform discarding of the RLC SDU corresponding to the SN in the RLC PDU; and
process reception of the RLC SDU corresponding to the SN as completed, and
wherein the at least one RLC SDU comprises at least one RLC SDU segment.

13. The RLC receiving side of claim 12, wherein the at least one controller is further configured to identify a type of the RLC PDU,
wherein, in case that the RLC PDU includes the SN, discarding of the RLC SDU corresponding to the SN is performed, and
wherein the RLC PDU is an RLC data PDU or an RLC control PDU.

14. The RLC receiving side of claim 12, wherein the SN is included in at least one of an RLC unacknowledged mode data (UMD) PDU, an RLC acknowledged mode data (AMD) PDU, or an RLC control PDU.
